(19) United States
(12) Patent Application Publication
(10) Pub. No.: US 2025/0094709 A1
(43) Pub. Date: Mar. 20, 2025

(54) ACCELERATING LANGUAGE MODEL INFERENCE WITH DYNAMIC MULTI-TOKEN SAMPLING

(71) Applicant: Samsung Electronics Co., Ltd., Suwon-si (KR)

(72) Inventors: Shikhar TULI, Sunnyvale, CA (US); Chi-Heng Lin, Mountain View, CA (US); Yen-Chang Hsu, Fremont, CA (US); Yilin Shen, Mountain View, CA (US); Hongxia Jin, San Jose, CA (US)

(73) Assignee: Samsung Electronics Co., Ltd., Suwon-si (KR)

(21) Appl. No.: 18/827,108

(22) Filed: Sep. 6, 2024

Related U.S. Application Data
(60) Provisional application No. 63/610,345, filed on Dec. 14, 2023.
(60) Provisional application No. 63/538,413, filed on Sep. 14, 2023.

(51) Int. Cl. G06F 40/284

(52) U.S. Cl. CPC G06F 40/284

(57) ABSTRACT

A method for performing multi-token prediction by an apparatus includes receiving, from an artificial intelligence (AI) assistance device, a request for an output token sequence that is subsequent to an input token sequence indicated by the request, predicting, by a trained machine learning model, a plurality of candidate output tokens, estimating joint probability distributions of one or more combinations of the plurality of candidate output tokens, calculating joint probabilities of the one or more combinations by masking the joint probability distributions with a co-occurrence weighted mask, determining, based on the joint probabilities, whether to reduce the number of candidate output tokens included in each combination of the one or more combinations, identifying, based on the joint probabilities, a combination of the one or more combinations as the output token sequence, and outputting, to the AI assistance device, a response to the request, the response comprising the output token sequence.

### CROSS-REFERENCE TO RELATED APPLICATIONS

This application claims benefit of priority under 35 U.S.C. § 119 to U.S. Provisional Patent Application No. 63/538,413, filed on Sep. 14, 2023, and U.S. Provisional Patent Application No. 63/610,345, filed on Dec. 14, 2023, in the U.S. Patent and Trademark Office, the disclosures of which are incorporated by reference herein in their entireties.

### BACKGROUND

### 1. Field

The present disclosure relates generally to language models, and more particularly to methods, apparatuses, systems, and non-transitory computer-readable mediums for accelerating language model inference with dynamic multi-token sampling.

### 2. Description of Related Art

Recent research may have demonstrated the use of large language models (LLMs) as competent artificial intelligence (AI) assistants. For at least such a reason, the adoption of LLMs as chatbots may have increased in diverse applications such as, but not limited to, healthcare, e-commerce, education, or the like. However, a rapid explosion in language model sizes may have resulted in high inference times. For example, the use of potentially massive closed-source corpora (e.g., text and/or speech data used to train the LLM) may have resulted in LLMs with relatively high computational requirements of LLM training and/or inference, which may restrict the development and/or deployment of LLMs.

In addition, related LLMs may only operate autoregressively. That is, the related LLMs may predict only one possible subsequent token at a time, given an input token sequence. Consequently, access and/or study of LLMs may remain limited due to challenges involved in the efficient evaluation of LLMs on resource-constrained devices edge platforms such as, but not limited to, mobile devices (e.g., smartphones, cellular phones, tablet computers, laptop computers, digital cameras, personal digital assistants (PDA), wearable devices, or the like), smart devices (e.g., voice-controlled virtual assistants, set-top boxes (STBs), refrigerators, air conditioners, microwave ovens, televisions (TVs), or the like), Internet of Things (IoT) devices, and/or any other type of data processing device.

Thus, there exists a need for further improvements to LLMs, as the need to deploy conversational AI agents on resource-constrained edge platforms may be constrained by resources (e.g., memory), time constraints (e.g., latency), and/or processing overheads. Improvements are presented herein. These improvements may also be applicable to other machine learning technologies and the standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, systems, and non-transitory computer-readable mediums for accelerating language model inference with dynamic multi-token sampling.

One or more example embodiments of the present disclosure provide for one or more language models for performing multi-token prediction, co-occurrence weighted masking, and/or adaptive thresholding with backing off.

According to an aspect of the present disclosure, a method for performing multi-token prediction by an apparatus includes receiving, from an artificial intelligence (AI) assistance device, a request for an output token sequence that is subsequent to an input token sequence indicated by the request, predicting, by a trained machine learning model, a plurality of candidate output tokens, estimating joint probability distributions of one or more combinations of the plurality of candidate output tokens, calculating joint probabilities of the one or more combinations by masking the joint probability distributions with a co-occurrence weighted mask, determining, based on the joint probabilities, whether to reduce the number of candidate output tokens included in each combination of the one or more combinations, identifying, based on the joint probabilities, a combination of the one or more combinations as the output token sequence, and outputting, to the AI assistance device, a response to the request. The trained machine learning model has been trained to simultaneously predict the plurality of candidate output tokens based on the input token sequence. Each combination of the one or more combinations has a number of candidate output tokens that corresponds to a target language generation speed. The response includes the output token sequence.

In some embodiments, the predicting of the plurality of candidate output tokens may include predicting each output token of the plurality of candidate output tokens by a corresponding token head of a plurality of token heads in a forward pass of the trained machine learning model. Each corresponding token head may be configured to provide a candidate output token in a corresponding position of the output token sequence.

In some embodiments, the predicting of each output token of the plurality of candidate output tokens may include predicting, by each corresponding token head of the plurality of token heads of the trained machine learning model, a plurality of logits corresponding to the plurality of candidate output tokens, selecting, for each corresponding token head of the plurality of token heads, a number of candidate output tokens from the target tokens based on probabilities of the plurality of logits, determining the one or more combinations by grouping a candidate output token from each corresponding token head. The estimating of the joint probability distributions may include calculating, for each combination of the one or more combinations, a joint probability of candidate output tokens associated with the corresponding combination. The determining whether to reduce the number of candidate output tokens may include determining whether at least one combination of the one or more combinations has a joint probability exceeding a probability threshold.

In some embodiments, the identifying of the combination of the one or more combinations may include identifying, based on determining that the combination exceeds the probability threshold, the combination as the output token sequence.

In some embodiments, the method may further include, based on determining that the one or more combinations do not exceed the probability threshold, determining new candidate token combinations including candidate output tokens from a portion of the plurality of token heads, calculating joint probabilities for the new candidate token combinations, and determining whether the joint probabilities of the new candidate token combinations exceed the probability threshold. The portion of the plurality of token heads may exclude at least one token head.

In some embodiments, the co-occurrence weighted mask may be independent of the input token sequence.

In some embodiments, the method may further include adapting the probability threshold based on the joint probability of the candidate output tokens using a binarization algorithm.

In some embodiments, the determining of the one or more combinations may include estimating a posterior probability of each combination of the one or more combinations using a bigram correlation function, and eliminating one or more combinations from the one or more combinations based on the posterior probabilities of the one or more combinations.

In some embodiments, the method may further include transferring, from a trained base model, weight information to a model stem and a first token head of a plurality of token heads of an untrained machine learning model, initializing weight information of remaining token heads of the plurality of token heads with randomized information, and training the model stem and the first token head at a first learning rate and training the remaining token heads at second learning rate to obtain the trained machine learning model. The second learning rate may be greater than the first learning rate.

In some embodiments, the method may further include receiving, from the AI assistance device, the target language generation speed, determining, based on the target language generation speed, a target number of output tokens to be included in the output token sequence, and predicting the target number of output tokens by a corresponding number of token heads of a plurality of token heads of the trained machine learning model.

According to an aspect of the present disclosure, an apparatus for performing multi-token prediction, includes one or more processors including processing circuitry, and memory storing instructions. The instructions, when executed by the one or more processors individually or collectively, cause the apparatus to receive, from an AI assistance device, a request for an output token sequence that is subsequent to an input token sequence indicated by the request, predict, by a trained machine learning model, a plurality of candidate output tokens, estimate joint probability distributions of one or more combinations of the plurality of candidate output tokens, calculate joint probabilities of the one or more combinations by masking the joint probability distributions with a co-occurrence weighted mask, determine, based on the joint probabilities, whether to reduce the number of candidate output tokens included in each combination of the one or more combinations, identify, based on the joint probabilities, a combination of the one or more combinations as the output token sequence, and output, to the AI assistance device, a response to the request. The trained machine learning model has been trained to simultaneously predict the plurality of candidate output tokens based on the input token sequence. Each combination of the one or more combinations has a number of candidate output tokens that corresponds to a target language generation speed. The response includes the output token sequence.

In some embodiments, the instructions, when executed by the one or more processors, further cause the apparatus to predict each output token of the plurality of candidate output tokens by a corresponding token head of a plurality of token heads in a forward pass of the trained machine learning model. Each corresponding token head may be configured to provide a candidate output token in a corresponding position of the output token sequence.

In some embodiments, the instructions, when executed by the one or more processors, further cause the apparatus to predict, by each corresponding token head of the plurality of token heads of the trained machine learning model, a plurality of logits corresponding to the plurality of candidate output tokens, select, for each corresponding token head of the plurality of token heads, a number of candidate output tokens from the target tokens based on probabilities of the plurality of logits, determine the one or more combinations by grouping a candidate output token from each corresponding token head, calculate, for each combination of the one or more combinations, a joint probability of candidate output tokens associated with the corresponding combination, and determine whether at least one combination of the one or more combinations has a joint probability exceeding a probability threshold.

In some embodiments, the instructions, when executed by the one or more processors, further cause the apparatus to identify, based on determining that the combination exceeds the probability threshold, the combination as the output token sequence.

In some embodiments, the instructions, when executed by the one or more processors, further cause the apparatus, based on a determination that the one or more combinations do not exceed the probability threshold, to determine new candidate token combinations including candidate output tokens from a portion of the plurality of token heads, calculate joint probabilities for the new candidate token combinations, and determine whether the joint probabilities of the new candidate token combinations exceed the probability threshold. The portion of the plurality of token heads may exclude at least one token head.

In some embodiments, the co-occurrence weighted mask may be independent of the input token sequence.

In some embodiments, the instructions, when executed by the one or more processors, further cause the apparatus to adapt the probability threshold based on the joint probability of the candidate output tokens using a binarization algorithm.

In some embodiments, the instructions, when executed by the one or more processors, further cause the apparatus to estimate a posterior probability of each combination of the one or more combinations using a bigram correlation function, and eliminate one or more combinations from the one or more combinations based on the posterior probabilities of the one or more combinations.

According to an aspect of the present disclosure, a system for performing multi-token prediction includes an AI assistance device and an apparatus. The apparatus includes one or more processors including processing circuitry, and memory storing instructions. The instructions, when executed by the one or more processors individually or collectively, cause the apparatus to receive, from the AI assistance device, a request for an output token sequence that is subsequent to an input token sequence indicated by the request, predict, by a trained machine learning model, a plurality of candidate output tokens, estimate joint probability distributions of one or more combinations of the plurality of candidate output tokens, calculate joint probabilities of the one or more combinations by masking the joint probability distributions with a co-occurrence weighted mask, determine, based on the joint probabilities, whether to reduce the number of candidate output tokens included in each combination of the one or more combinations, identify, based on the joint probabilities, a combination of the one or more combinations as the output token sequence, and output, to the AI assistance device, a response to the request, the response including the output token sequence. The trained machine learning model has been trained to simultaneously predict the plurality of candidate output tokens based on the input token sequence. Each combination of the one or more combinations having a number of candidate output tokens that corresponds to a target language generation speed.

In some embodiments, the instructions, when executed by the one or more processors, further cause the apparatus to predict each output token of the plurality of candidate output tokens by a corresponding token head of a plurality of token heads in a forward pass of the trained machine learning model. Each corresponding token head may be configured to provide a candidate output token in a corresponding position of the output token sequence.

According to an aspect of the present disclosure, an apparatus for performing multi-token prediction includes means for receiving, from an AI assistance device, a request for an output token sequence that is subsequent to an input token sequence indicated by the request, means for predicting, by a trained machine learning model, a plurality of candidate output tokens, means for estimating joint probability distributions of one or more combinations of the plurality of candidate output tokens, means for calculating joint probabilities of the one or more combinations by masking the joint probability distributions with a co-occurrence weighted mask, means for determining, based on the joint probabilities, whether to reduce the number of candidate output tokens included in each combination of the one or more combinations, means for identifying, based on the joint probabilities, a combination of the one or more combinations as the output token sequence, and means for outputting, to the AI assistance device, a response to the request. The trained machine learning model has been trained to simultaneously predict the plurality of candidate output tokens based on the input token sequence. Each combination of the one or more combinations has a number of candidate output tokens that corresponds to a target language generation speed. The response includes the output token sequence.

According to an aspect of the present disclosure, a non-transitory computer-readable storage medium storing computer-executable instructions for performing multi-token prediction by an apparatus is provided. The computer-executable instructions are configured, when executed by one or more processors of the apparatus, to receive, from an AI assistance device, a request for an output token sequence that is subsequent to an input token sequence indicated by the request, predict, by a trained machine learning model, a plurality of candidate output tokens, estimate joint probability distributions of one or more combinations of the plurality of candidate output tokens, calculate joint probabilities of the one or more combinations by masking the joint probability distributions with a co-occurrence weighted mask, determine, based on the joint probabilities, whether to reduce the number of candidate output tokens included in each combination of the one or more combinations, identify, based on the joint probabilities, a combination of the one or more combinations as the output token sequence, and output, to the AI assistance device, a response to the request. The trained machine learning model has been trained to simultaneously predict the plurality of candidate output tokens based on the input token sequence. Each combination of the one or more combinations has a number of candidate output tokens that corresponds to a target language generation speed. The response includes the output token sequence.

Additional aspects are set forth in part in the description that follows and, in part, may be apparent from the description, or may be learned by practice of the presented embodiments of the disclosure.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates an exemplary device that may be used in implementing one or more aspects of the present disclosure;

FIG. 2 depicts an example of an autoregressive language prediction model, in accordance with various aspects of the present disclosure;

FIG. 3 illustrates an example of a multi-token prediction language model, in accordance with various aspects of the present disclosure;

FIG. 4 depicts an exemplary training method of a multi-token prediction language model, in accordance with various aspects of the present disclosure;

FIG. 5 illustrates an example of a multi-token prediction language model, in accordance with various aspects of the present disclosure;

FIG. 6 depicts an exemplary dynamic multi-token prediction language model (DynaMo) multi-token generation algorithm, in accordance with various aspects of the present disclosure;

FIG. 7 illustrates an example of a multi-token prediction language model, in accordance with various aspects of the present disclosure;

FIG. 8 depicts an example of hypothesis reduction, in accordance with various aspects of the present disclosure;

FIG. 9 illustrates an example of posterior estimation, in accordance with various aspects of the present disclosure;

FIG. 10 depicts an exemplary speculative decoding with hypothesis reduction algorithm, in accordance with various aspects of the present disclosure;

FIG. 11 illustrates an exemplary flowchart of a hypothesis reduction method, in accordance with various aspects of the present disclosure;

FIG. 12 depicts an example of a user interface for selecting a language generation speed, in accordance with various aspects of the present disclosure;

FIG. 13 illustrates a block diagram of an example apparatus for performing multi-token prediction, in accordance with various aspects of the present disclosure; and

FIG. 14 depicts a flowchart of an example method for performing multi-token prediction, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it is to be apparent to those skilled in the art that these concepts may be practiced without these specific details. In some instances, well known structures and components are shown in block diagram form in order to avoid obscuring such concepts. In the descriptions that follow, like parts are marked throughout the specification and drawings with the same numerals, respectively.

The following description provides examples, and is not limiting of the scope, applicability, or embodiments set forth in the claims. Changes may be made in the function and/or arrangement of elements discussed without departing from the scope of the present disclosure. Various examples may omit, substitute, or add various procedures or components as appropriate. For example, the methods described may be performed in an order different from that described, and various steps may be added, omitted, and/or combined. Alternatively or additionally, features described with reference to some examples may be combined in other examples.

Various aspects and/or features may be presented in terms of systems that may include a number of devices, components, modules, or the like. It is to be understood and appreciated that the various systems may include additional devices, components, modules, or the like and/or may not include all of the devices, components, modules, or the like discussed in connection with the figures. A combination of these approaches may also be used.

As a general introduction to the subject matter described in more detail below, aspects described herein are directed towards apparatuses, methods, systems, and non-transitory computer-readable mediums for accelerating language model inference with dynamic multi-token sampling. Aspects presented herein may provide for multi-token prediction language models that may potentially reduce net (or total) inference times.

Large language models (LLMs) may be competent as artificial intelligence (AI) assistants. However, at least due in part to the relatively large size of related LLMs and the relatively high computational requirements of LLM training and/or inference, deployment of LLMs as conversational AI agents to resource-constrained edge platforms may present a challenge. For example, such deployments may result in significant latencies that may negatively affect a user experience.

In an embodiment, aspects presented herein may provide for multi-token prediction language models that may dynamically predict multiple tokens based on a confidence in a predicted joint probability distribution. Furthermore, aspects presented herein may provide for training the multi-token prediction language models in a manner that may leverage the weights of related autoregressive language models. In addition, aspects presented herein may provide for systematic qualitative and/or quantitative methods to test the quality of text generated by the multi-token prediction language models.

In an embodiment, the multi-token prediction language models described herein may achieve speed improvements, when compared to related language models, while generating text with a substantially similar quality as the related language models.

Although the present disclosure describes the use of multi-token prediction language models in conjunction with virtual assistants, the present disclosure is not limited in this regard. For example, the concepts described herein may be applied to other use cases, such as, but not limited to, language translation, sentiment analysis, fraud detection, question answering, software development, customized learning and/or tutoring, text generation, content generation, chatbots, conversational AI, personalized marketing, medical diagnosis, summarization, customer service, or the like.

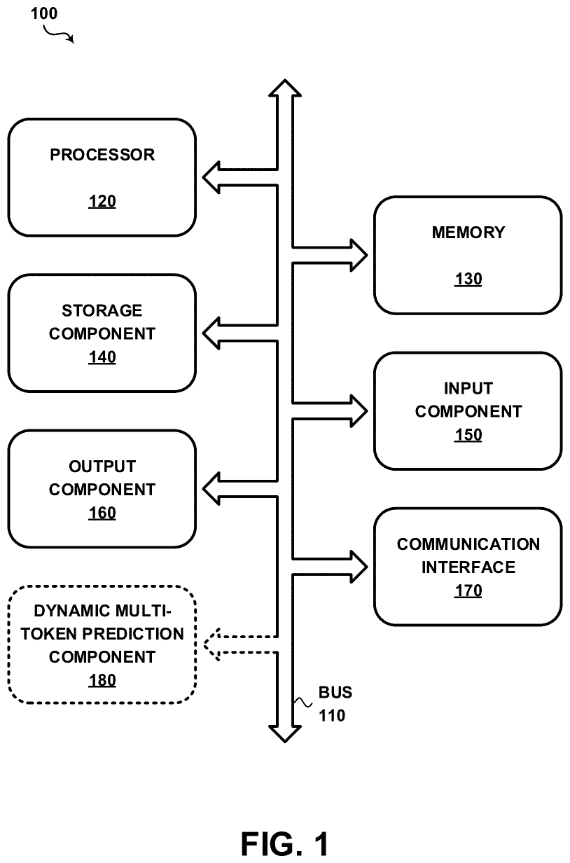

As noted above, certain embodiments are discussed herein that relate to performing multi-token prediction. Before discussing these concepts in further detail, however, an example of a computing device that may be used in implementing and/or otherwise providing various aspects of the present disclosure is discussed with respect to FIG. 1.

FIG. 1 illustrates an exemplary device 100 that may be used in implementing one or more aspects of the present disclosure. For example, the device 100 may, in some instances, implement one or more aspects of the present disclosure by reading and/or executing instructions and performing one or more actions accordingly. In one or more arrangements, device 100 may represent, be incorporated into, and/or include a processor, a personal computer (PC), a printed circuit board (PCB) including a computing device, a minicomputer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device. Alternatively or additionally, the device 100 may represent, be incorporated into, and/or include a desktop computer, a computer server, a virtual machine, a network appliance, a mobile device (e.g., a user equipment (UE), a laptop computer, a tablet computer, a PDA, a smart phone, any other type of mobile computing device, or the like), a camera, a wearable device (e.g., smart watch, headset, headphones, or the like), a smart device (e.g., a voice-controlled virtual assistant, a set-top box (STB), a refrigerator, an air conditioner, a microwave, a television (TV), or the like), an Internet-of-Things (IoT) device, and/or any other type of data processing device.

For example, the device 100 may include a processor, a PC, a PCB including a computing device, a mini-computer, a mainframe computer, a microcomputer, a telephonic computing device (e.g., a cellular phone, a smart phone, a session initiation protocol (SIP) phone, a wired/wireless computing device (e.g., a smartphone, a PDA), a laptop, a tablet, a smart device, a wearable device, or any other similar functioning device.

In an embodiment, as shown in FIG. 1, the device 100 may include a set of components, such as a processor 120, a memory 130, a storage component 140, an input component 150, an output component 160, a communication interface 170, and a dynamic multi-token prediction component 180. The set of components of the device 100 may be communicatively coupled via a bus 110.

The bus 110 may include one or more components that may permit communication among the set of components of the device 100. For example, the bus 110 may be a communication bus, a cross-over bar, a network, or the like. Although the bus 110 is depicted as a single line in FIG. 1, the bus 110 may be implemented using multiple (e.g., two (2) or more) connections between the set of components of device 100. The present disclosure is not limited in this regard.

The device 100 may include one or more processors, such as the processor 120. The processor 120 may be implemented in hardware, firmware, and/or a combination of hardware and software. For example, the processor 120 may include a central processing unit (CPU), an application processor (AP), a graphics processing unit (GPU), an accelerated processing unit (APU), a microprocessor, a microcontroller, a digital signal processor (DSP), a field-programmable gate array (FPGA), an application-specific integrated circuit (ASIC), an image signal processor (ISP), a neural processing unit (NPU), a sensor hub processor, a communication processor (CP), an AI-dedicated processor designed to have a hardware structure specified to process an AI model, a general purpose single-chip and/or multi-chip processor, or other programmable logic device, discrete gate or transistor logic, discrete hardware components, or any combination thereof designed to perform the functions described herein. A general-purpose processor may include a microprocessor, or any conventional processor, controller, microcontroller, or state machine.

The processor 120 may also be implemented as a combination of computing devices, such as a combination of a DSP and a microprocessor, a combination of a main processor and an auxiliary processor, a plurality of microprocessors, one or more microprocessors in conjunction with a DSP core, or any other such configuration. In some embodiments, particular processes and methods may be performed by circuitry that is specific to a given function. In optional or additional embodiments, an auxiliary processor may be configured to consume less power than the main processor. Alternatively or additionally, the one or more processors may be implemented separately (e.g., as several distinct chips) and/or may be combined into a single form.

The processor 120 may control overall operation of the device 100 and/or of the set of components of device 100 (e.g., the memory 130, the storage component 140, the input component 150, the output component 160, the communication interface 170, and the dynamic multi-token prediction component 180).

The device 100 may further include the memory 130. In some embodiments, the memory 130 may include volatile memory such as, but not limited to, random access memory (RAM), static RAM (SRAM), dynamic RAM (DRAM), or the like. In optional or additional embodiments, the memory 130 may include non-volatile memory such as, but not limited to, read only memory (ROM), electrically erasable programmable ROM (EEPROM), NAND flash memory, phase-change RAM (PRAM), magnetic RAM (MRAM), resistive RAM (RRAM), ferroelectric RAM (FRAM), magnetic memory, optical memory, or the like. However, the present disclosure is not limited in this regard, and the memory 130 may include other types of dynamic and/or static memory storage. In an embodiment, the memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid-state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further include the input component 150. The input component 150 may include one or more components that may permit the device 100 to receive (e.g., obtain) information, such as via user input (e.g., a touch screen, a keyboard, a keypad, a mouse, a stylus, a button, a switch, a microphone, a camera, a virtual reality (VR) headset, haptic gloves, or the like). Alternatively or additionally, the input component 150 may include one or more sensors for sensing information (e.g., a global positioning system (GPS) component, an accelerometer, a gyroscope, an actuator, a transducer, a contact sensor, a proximity sensor, a ranging device, a camera, a video camera, a depth camera, a time-of-flight (TOF) camera, a stereoscopic camera, or the like). In an embodiment, the input component 150 may include more than one of a same sensor type (e.g., multiple cameras).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, a buzzer, an alarm, or the like).

The device 100 may further include the communication interface 170. The communication interface 170 may include a receiver component, a transmitter component, and/or a transceiver component. The communication interface 170 may enable the device 100 to establish connections and/or transfer communications with other devices (e.g., an AI assistance device, a server, a laptop, a smartphone, a UE, a camera, a wearable device, a smart device, an IoT device, or the like). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fourth generation (4G) network, a fifth generation (5G) network, a long-term evolution (LTE) network, a third generation (3G) network, a code division multiple access (CDMA) network, or the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as, FlashLinQ, WiMedia, Bluetooth™, Bluetooth™ Low Energy (BLE), ZigBee, Institute of Electrical and Electronics Engineers (IEEE) 802.11x (Wi-Fi), LTE, 4G, 5G, or the like. In optional or additional embodiments, the communication interface 170 may include an Ethernet interface, an optical interface, a coaxial interface, an infrared interface, a radio frequency (RF) interface, a USB interface, an IEEE 1094 (FireWire) interface, or the like.

In some embodiments, the device 100 may include the dynamic multi-token prediction component 180, which may be configured to perform multi-token prediction. For example, the dynamic multi-token prediction component 180 may be configured to receive a request for an output token sequence, predict a plurality of candidate output tokens, estimate joint probability distributions of one or more combinations of the plurality of candidate output tokens, calculate joint probabilities of the one or more combinations, determine whether to reduce the number of candidate output tokens included in each combination of the one or more combinations, identify a combination of the one or more combinations as the output token sequence, and output a response to the request including the output token sequence.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A non-transitory memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two (2) or more components shown in FIG. 1 may be implemented within a single component, or a single component shown in FIG. 1 may be implemented as multiple, distributed components. Alternatively or additionally, a set of (one or more) components shown in FIG. 1 may perform one or more functions described as being performed by another set of components shown in FIG. 1.

Having discussed an example of a device that may be used in providing and/or implementing various aspects of the present disclosure, a number of embodiments are now discussed in further detail. In particular, and as introduced above, some aspects of the present disclosure generally relate to performing multi-token prediction.

Related LLMs may be trained with a causal language modeling (CLM) objective to predict one subsequent token at a time. Such LLMs may be referred to as autoregressive language prediction models and/or may be conceptualized as V-way classifiers and/or unigram predictors, where V may represent the vocabulary size of the model (e.g., V is a positive integer greater than one (1)).

The autoregressive language prediction models may model a probability distribution p that may be represented as an equation similar to Equation 1.

$$p ( {x}_{t + 1} \vert {x}_{1 : t} ) = {f}_{θ} ( {x}_{1 : t} ) \qquad [ Eq . 1 ]$$

Referring to Equation 1, f_{θ} may represent the autoregressive language prediction model as parameterized by θ, and x_{1:t} may represent the context (e.g., the set of past tokens, x_{1:t}:=x₁, x₂, . . . , xₜ) of the predicted token xₜ₊₁. That is, the autoregressive language prediction model may generate text sequences by autoregressively predicting a subsequent token based on an input token sequence of previous tokens. For example, a first predicted token xₜ₊₁ may be sampled from f_{θ}(x_{1:t}) using the first input token sequence x_{1:t}, and may be concatenated with the first input token sequence to produce a second input token sequence x_{1:t+1}:=x₁, x₂, . . . , xₜ, xₜ₊₁. As an example, a second predicted token xₜ₊₂ may be sampled from f_{θ}(x_{1:t+1}) using the second input token sequence x_{1:t+1}, and may be concatenated with the second input token sequence to produce a third input token sequence x_{1:t+2}:=x₁, x₂, . . . , xₜ, xₜ₊₁, xₜ₊₂. As an example, a third predicted token xₜ₊₃ may be sampled from f_{θ}(x_{1:t+2}) using the third input token sequence x_{1:t+2}.

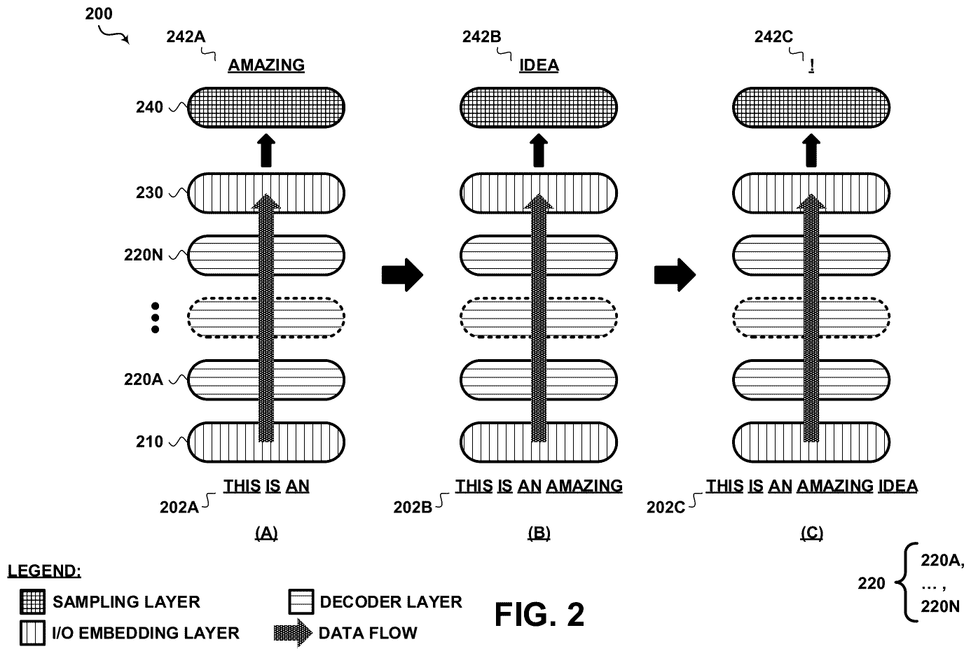

FIG. 2 depicts an example of an autoregressive language prediction model, in accordance with various aspects of the present disclosure.

Referring to FIG. 2, at least a portion of the operations of the autoregressive language prediction model 200 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the autoregressive language prediction model 200. That is, the device 100 may perform a portion of the autoregressive language prediction model 200 as described with reference to FIG. 2 and a remaining portion of the autoregressive language prediction model 200 may be performed by one or more other computing devices.

In an embodiment, the autoregressive language prediction model 200 may be and/or may include an LLM such as, but not limited to, a bidirectional encoder transformer (BERT), Claude LLM, Cohere, Ernie, Falcon 40B, Gemini, a Generative Pre-trained Transformer (GPT), Language Model for Dialogue Applications (Lamda), Large Language Model Meta AI (Llama), Pythia, or the like.

As shown in FIG. 2, the autoregressive language prediction model 200 may include an input embedding layer 210, a plurality of decoder layers 220 (e.g., a first decoder layer 220A to an N-th decoder layer 220N, where N is a positive integer greater than one (1)), an output embedding layer 230, and a sampling layer 240. Although FIG. 2 depicts an example of the autoregressive language prediction model 200 as having two (2) decoder layers, the present disclosure is not limited in this regard. For example, the autoregressive language prediction model 200 may include fewer decoder layers 220 (e.g., one (1) decoder layer) or may include more decoder layers 220 (e.g., three (3) or more decoder layers) than those depicted in FIG. 2. In addition, it is to be understood that the autoregressive language prediction model 200 may include additional layers, fewer layers, different layers, or differently arranged layers than those depicted in FIG. 2. For example, two (2) or more layers of the autoregressive language prediction model 200 may be merged into one (1) layer, and/or one (1) layer of the autoregressive language prediction model 200 may be split into two (2) or more layers.

As shown in (A) of FIG. 2, the autoregressive language prediction model 200 may perform a first forward pass to predict a first predicted token xₜ₊₁ 242A (e.g., “amazing”) that may be sampled from f_{θ}(x_{1:t}) using the first input token sequence x_{1:t} 202A (e.g., “This”, “is”, “an”).

As shown in (B) of FIG. 2, the autoregressive language prediction model 200 may perform a second forward pass to predict a second predicted token xₜ₊₂ 242B (e.g., “idea”) that may be sampled from f_{θ}(x_{1:t+1}) using the second input token sequence x_{1:t+1} 202B (e.g., “This”, “is”, “an”, “amazing”).

As shown in (C) of FIG. 2, the autoregressive language prediction model 200 may perform a third forward pass to predict a third predicted token xₜ₊₃ 242C (e.g., “!”) that may be sampled from f_{θ}(x_{1:t+2}) using the third input token sequence x_{1:t+2} 202C (e.g., “This”, “is”, “an”, “amazing”, “idea”).

That is, the autoregressive language prediction model 200 may need to perform a single forward pass to add each predicted token to the input token sequence. For example, as shown in FIG. 2, the autoregressive language prediction model 200 may need to perform three (3) forward passes to add three (3) predicted tokens (e.g., “amazing”, “idea”, and “!”) to the original input token sequence (e.g., “This”, “is”, “an”).

Consequently, a net (or total) interference time for generating a token sequence using the autoregressive language prediction model 200 may linearly increase as the number of predicted tokens increases. Increasing LLM sizes due to potentially massive closed-source corpora (e.g., text and/or speech data used to train the LLM), as well as, relatively high computational requirements of LLM inference may exacerbate this issue, and may result in significantly high net inference times for such LLMs.

To potentially alleviate these issues, LLM training and/or inference may be limited to large GPU clusters in data centers even though such deployments may result in substantial latencies for end-users, as well as, may introduce privacy concerns. Thus, it may be preferable to instead deploy the LLMs to edge platforms (e.g., edge servers, mobile devices) to potentially avoid the latencies and/or the privacy concerns brought about by the deployments in data centers. However, the high inference times of related LLMs may potentially present challenges for deployments at edge platforms.

Recent research in psycholinguistics may show that humans may not necessarily think of words one at a time when articulating thought, and instead, may employ a parallel network of cognitive and/or linguistic processes to simultaneously think of several words. In line with such research, aspects of the present disclosure provide for a multi-token prediction language model that may simultaneously predict multiple tokens, and thereby, potentially reduce net inference times when compared to related language prediction models.

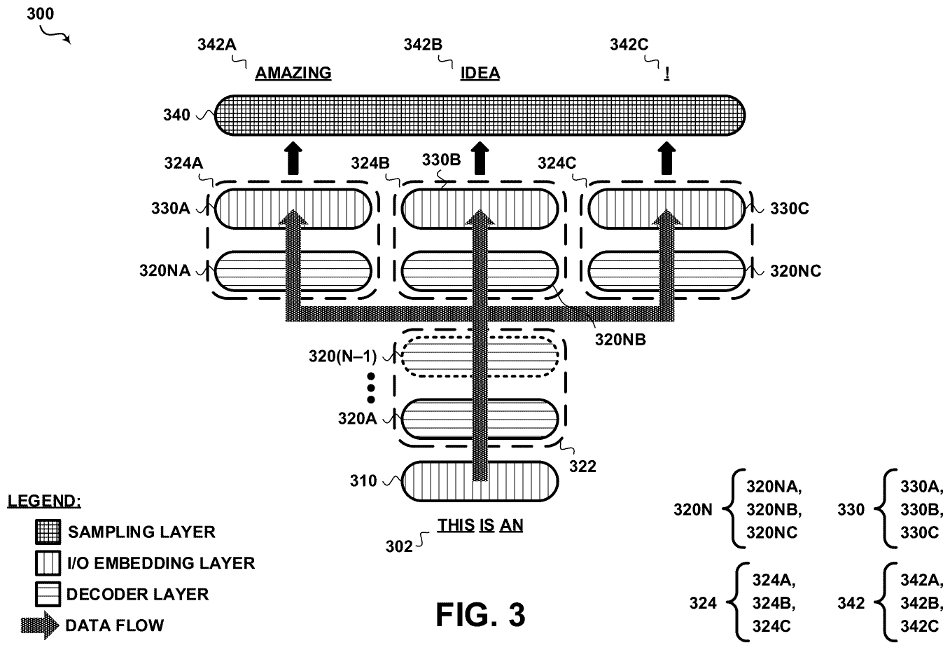

FIG. 3 illustrates an example of a multi-token prediction language model, in accordance with various aspects of the present disclosure.

Referring to FIG. 3, at least a portion of the operations of the multi-token prediction language model 300 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the multi-token prediction language model 300. That is, the device 100 may perform a portion of the multi-token prediction language model 300 as described with reference to FIG. 3 and a remaining portion of the multi-token prediction language model 300 may be performed by one or more other computing devices.

The multi-token prediction language model 300 may include an input embedding layer 310, a stem 322 including a plurality of decoder layers (e.g., a first decoder layer 320A to an (N−1)-th decoder layer 320(N−1), where N is a positive integer greater than one (1)), a plurality of N-th decoder layers 320N (e.g., a first N-th decoder layer 320NA, a second N-th decoder layer 320NB, and a third N-th decoder layer 320NC), a plurality of output embedding layers 330 (e.g., a first output embedding layer 330A, a second output embedding layer 330B, and a third output embedding layer 330C), and a sampling layer 340.

The multi-token prediction language model 300 of FIG. 3 may include and/or may be similar in many respects to the autoregressive language prediction model 200 described above with reference to FIG. 2, and may include additional features not mentioned above. Furthermore, the input embedding layer 310, the plurality of decoder layers 320, the output embedding layer 330, and the sampling layer 340 may include and/or may be similar in many respects, respectively, to the input embedding layer 210, the plurality of decoder layers 220, the I/O embedding layer 230, and the sampling layer 240 described above with reference to FIG. 2, and may include additional features not mentioned above. Consequently, repeated descriptions of the multi-token prediction language model 300 and/or its components described above with reference to FIG. 2 may be omitted for the sake of brevity.

In an embodiment, the multi-token prediction language model 300 may form a plurality of token predicting heads 324 (e.g., a first token predicting head 324A, a second token predicting head 324B, and a third token predicting head 324C). The first token predicting head 324A may be formed from the first N-th decoder layer 320NA and the first output embedding layer 330A. The second token predicting head 324B may be formed from the second N-th decoder layer 320NB and the second output embedding layer 330B. The third token predicting head 324C may be formed from the third N-th decoder layer 320NC and the third output embedding layer 330C.

Although FIG. 3 illustrates an example of the multi-token prediction language model 300 as having three (3) decoder layers and three (3) token predicting heads, the present disclosure is not limited in this regard. For example, the multi-token prediction language model 300 may include fewer decoder layers (e.g., two (2) decoder layers) or may include more decoder layers (e.g., three (3) or more decoder layers) than those illustrates in FIG. 3. As an example, the multi-token prediction language model 300 may include fewer token predicting heads 324 (e.g., one (1) or two (2) token predicting heads) or may include more token predicting heads 324 (e.g., three (3) or more token predicting heads) than those illustrates in FIG. 3. In addition, it is to be understood that the multi-token prediction language model 300 may include additional layers, fewer layers, different layers, or differently arranged layers than those illustrates in FIG. 3. For example, two (2) or more layers of the multi-token prediction language model 300 may be merged into one (1) layer, and/or one (1) layer of the multi-token prediction language model 300 may be split into two (2) or more layers.

Multi-token prediction language models, such as the multi-token prediction language model 300 of FIG. 3, may be conceptualized as Vⁿ-way classifiers, where V may represent the vocabulary size of the model and n may represent the number of tokens (e.g., token heads) generated by the model (e.g., n is a positive integer greater than one (1)). For example, the multi-token prediction language model 300 of FIG. 2 may be conceptualized as a V³-way model. The multi-token prediction language model 300 may model a probability distribution p that may be represented as an equation similar to Equation 2.

$$p ( {x}_{t + 1 : t + n} \vert {x}_{1 : t} ) = {f}_{θ} \qquad [ Eq . 2 ]$$

Referring to Equation 2, f_{θ} may represent the multi-token prediction language model as parameterized by θ, n may represent the number of token heads in the multi-token prediction language model, and x_{1:t} may represent the context (e.g., the set of past tokens, x_{1:t}:=x₁, x₂, . . . , xₜ) of the predicted tokens x_{+1:t+n}. That is, the multi-token prediction language model may generate text sequences by simultaneously (e.g., in a same forward pass) predicting n subsequent tokens based on an input token sequence of previous tokens. For example, n may be equal to three (3) (e.g., n=3) for the multi-token prediction language model 300 illustrated in FIG. 3, and as such, may predict a plurality of three (3) predicted tokens 342 (e.g., a first predicted token xₜ₊₁ 342A, a second predicted token xₜ₊₂ 342B, and a third predicted token xₜ₊₃ 342C) in a same forward pass of the multi-token prediction language model 300.

As shown in FIG. 3, the multi-token prediction language model 300 may perform a single forward pass to predict the first predicted token xₜ₊₁ 342A (e.g., “amazing”), the second predicted token xₜ₊₂ 342B (e.g., “idea”), and the third predicted token xₜ₊₃ 342C (e.g., “!”), which may be sampled from f_{θ}(x_{1:t}) using the input token sequence x_{1:t} 302 (e.g., “This”, “is”, “an”).

In an embodiment, the multi-token prediction language model 300 may receive a request for an output token sequence 342 that may include the input token sequence x_{1:t} 302. For example, the multi-token prediction language model 300 may receive the request from an AI assistance device, however, the present disclosure is not limited in this regard.

Consequently, the multi-token prediction language model 300 may achieve a three times (×3) inference speed-up (assuming no latency overhead) when compared to the autoregressive language prediction model 200 described above with reference to FIG. 2.

Various aspects of the present disclosure may provide for improvements in inference speed by augmenting related LLMs in terms of model architecture, training methodology, and non-autoregressive decoding schemes. The non-autoregressive decoding approaches aim to improve the inference speed of translation models by only requiring a single forward pass to generate the output sequence instead of iteratively producing each predicted token.

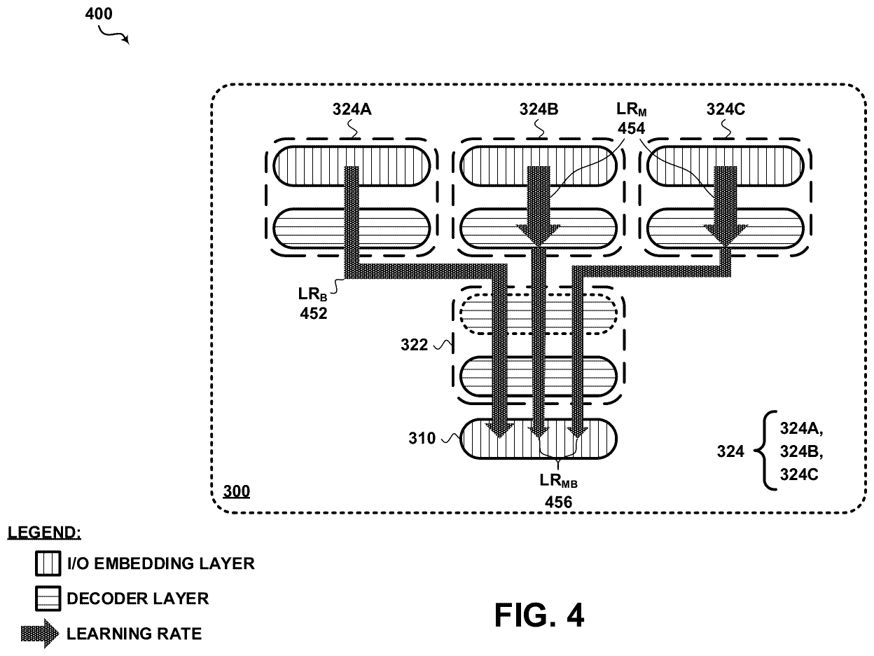

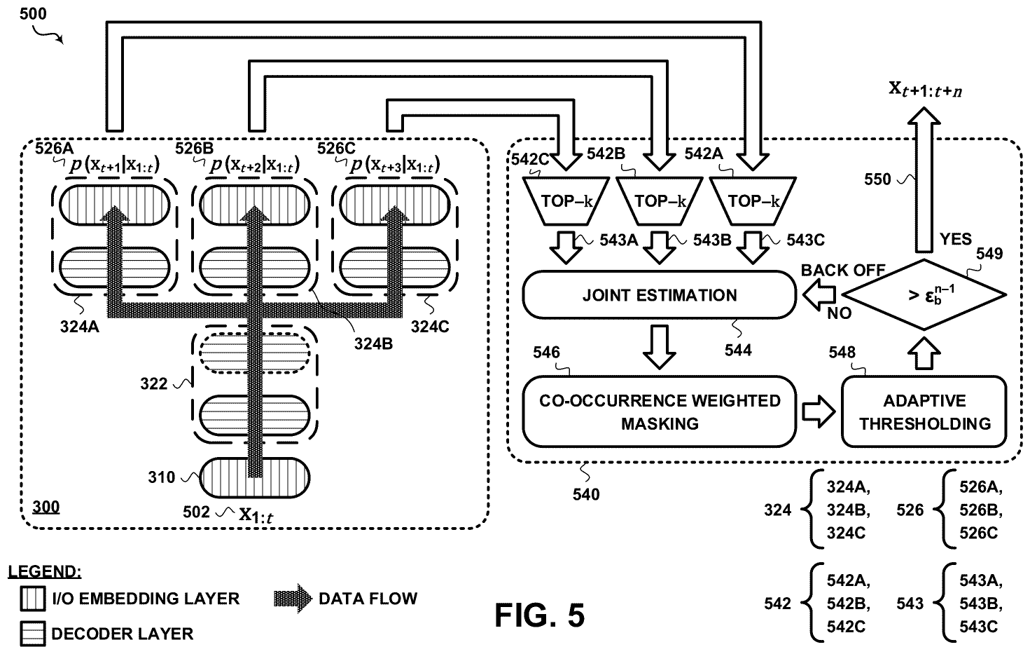

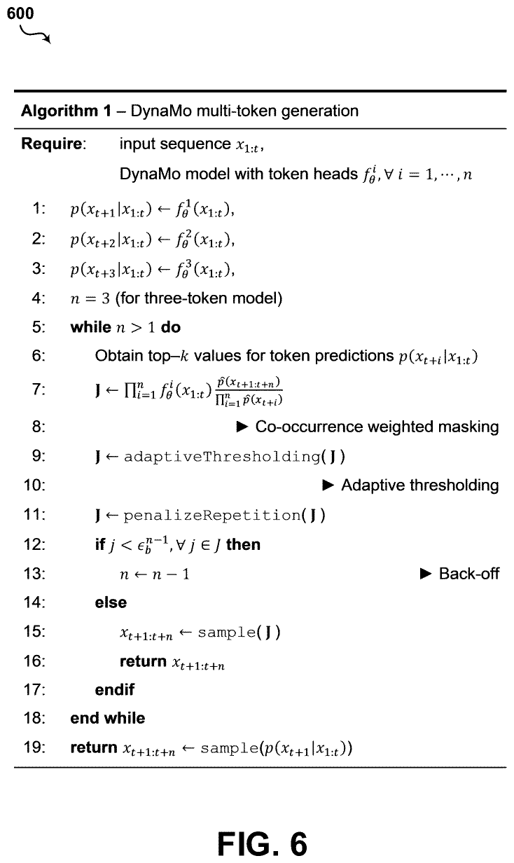

In an embodiment, the multi-token prediction language model 300 may be and/or may include an augmented LLM based on a related LLM. For example, the multi-token prediction language model 300 may be augmented to include a plurality of token heads 324. Alternatively or additionally, the multi-token prediction language model 300 may be trained by training a pre-trained LLM for multi-token prediction as described with reference to FIG. 4. As an example, the multi-token prediction language model 300 may be augmented to dynamically predict multiple tokens based on the current context and probabilities of predicted tokens and to back off to a lower-order n-gram prediction when joint probabilities of the predicted tokens do not exceed a predetermined threshold as described with reference to FIGS. 5 and 6.

FIG. 4 depicts an exemplary training method of the multi-token prediction language model 300, in accordance with various aspects of the present disclosure.

Referring to FIG. 4, at least a portion of the training method 400 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the training method 400. That is, the device 100 may perform a portion of the training method 400 as described with reference to FIG. 4 and a remaining portion of the training method 400 may be performed by one or more other computing devices.

The multi-token prediction language model 300 may be trained with a modified-CLM objective for multi-token prediction. For example, during the training method 400, the loss [symbol] for each n^{th} token head of the multi-token prediction language model 300 may be represented as an equation similar to Equation 3.

$${ℒ}_{Tn} = - \frac{1}{N} {\sum }_{j = 1}^{N} {\sum }_{t = 1}^{L - n + 1} log p ( {x}_{t + n}^{j} \vert {x}_{1 : t}^{j} ) \qquad [ Eq . 3 ]$$

Referring to Equation 3, N may represent the number of sequences in the training set, and the length of the j^{th} sequence may be represented by L.

In an embodiment, a previously-trained LLM (e.g., Pythia) may be used as a base model of the multi-token prediction language model 300. However, the present disclosure is not limited in this regard, and other machine learning models may be used without departing from the scope of the present disclosure. That is, the training method 400 may include transferring the weights and/or hyperparameters of the previously-trained LLM to the input embedded layer 310, the stem 322, and the first token predicting head 324A of the multi-token prediction language model 300 from corresponding I/O embedding layers and/or decoder layers of the previously-trained LLM. Alternatively or additionally, the weights and/or hyperparameters of the remaining token predicting heads of the plurality of token predicting heads 324 (e.g., the second token predicting head 324B and the third token predicting head 324C) may be initialized using randomized values.

The training method 400 may include training the multi-token prediction language model 300 with a randomly sampled portion of a training dataset that has been used to train the previously-trained LLM. That is a subset of the same dataset on which the previously-trained LLM has been trained may be chosen to potentially avoid catastrophic forgetting that may occur when a portion of a machine learning model is trained on a different dataset. For example, in a case in which the Pile dataset has been used to train the previously-trained LLM, the training method 400 may randomly sample a portion of k % sentences from the Pile dataset, where k is a positive value ranging from 0% to 100%. In an embodiment, the training method 400 may sample 5% (e.g., k=5%) of the sentences included the Pile dataset. However, the present disclosure is not limited in this regard, and portions including a smaller quantity of sentences (e.g., k<5%) or a larger quantity of sentences (e.g., k>5%) may be sampled. In addition, another dataset other than the Pile dataset may be used to train the previously-trained LLM as well as the multi-token prediction language model 300. Alternatively or additionally, the previously-trained LLM and the multi-token prediction language model 300 may be trained on other datasets using related continual learning approaches.

As shown in FIG. 4, the training method 400 may include training the first token predicting head 324A and the stem 322 using a low learning rate LR_{B} 452. The first token predicting head 324A and the stem 322 may be trained using the low learning rate LR_{B} 452 because such elements may be already trained by virtue of being initialized with the weights and/or hyperparameters of the previously-trained LLM. The remaining token predicting heads of the plurality of token predicting heads 324 (e.g., the second token predicting head 324B and the third token predicting head 324C) may be trained using a higher learning rate LR_{M} 454 (e.g., LR_{M}>LR_{B}). The remaining token predicting heads may be trained using the higher learning rate LR_{M} 454 because such elements may have randomly initialized weights and/or hyperparameters. However, when backpropagating those gradients to the stem 322, a much lower learning rate LR_{MB} 456 (e.g., LR_{MB}<LR_{B}<LR_{M}) may be used.

In an embodiment, an optimizer (e.g., AdamW optimizer) may be used to train the multi-token prediction language model 300. However, the present disclosure is not limited in this regard, and other approaches may be implemented for training the multi-token prediction language model 300. Alternatively or additionally, a cosine learning rate scheduler may be used such that the learning rate may warm up for a first portion of the training dataset (e.g., 1% or 758 steps), and may then drop to zero (0) at the end of the training. However, the present disclosure is not limited in this regard, and other approaches may be implemented for training the multi-token prediction language model 300.

In an embodiment, the randomly sampled dataset used to train the multi-token prediction language model 300 may be divided into a training set used to train the multi-token prediction language model 300, and a validation set, different from the training set, for validating the training of the multi-token prediction language model 300. The size of the training set may be comparatively larger than the size of the validation set. For example, the training set may include 97% of the randomly sampled dataset and the validation set may include 3% of the randomly sampled dataset. However, the present disclosure is not limited in this regard. That is, the training set and the validation set may include different portions of the randomly sampled dataset without departing from the scope of the present disclosure.

The training method 400 may be configured to have a batch size of b sentences. That is, the training method 400 may provide, to the multi-token prediction language model 300, a batch of b sentences prior to the multi-token prediction language model 300 updating its weights and/or hyperparameters based on the training. For example, assuming that the training set includes 97% of a randomly sampled dataset that includes 5 million sentences, each sentence is 2,048 tokens long, and a batch size of 64 sentences is selected (e.g., b=64), each batch may include 131,072 tokens (e.g., 2,048×64=131,072) and one training epoch (e.g., a complete pass through the training set) may include 75,782 training steps (e.g., (5,000,000×97%)/64). In such an example, the multi-token prediction language model 300 may be evaluated (e.g., determine loss [symbol] ) at every 5,000 steps. However, the present disclosure is not limited in this regard, and other batch sizes, training dataset sizes, and evaluation periods may be used without departing from the scope of the present disclosure.

FIG. 5 illustrates an example of a multi-token prediction language model, in accordance with various aspects of the present disclosure.

Referring to FIG. 5, at least a portion of the operations of the multi-token prediction language model 500 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the multi-token prediction language model 500. That is, the device 100 may perform a portion of the multi-token prediction language model 500 as described with reference to FIG. 5 and a remaining portion of the multi-token prediction language model 500 may be performed by one or more other computing devices.

The multi-token prediction language model 500 of FIG. 5 may include and/or may be similar in many respects to the multi-token prediction language model 300 described above with reference to FIG. 3, and may include additional features not mentioned above. Consequently, repeated descriptions of the multi-token prediction language model 500 and/or its components described above with reference to FIG. 3 may be omitted for the sake of brevity.

In an embodiment, the multi-token prediction language model 500 may include the input embedding layer 310, the stem 322 (including the first decoder layer 320A to the (N−1)-th decoder layer 320 (N−1)), the plurality of token predicting heads 324 (each token predicting head formed from the corresponding N-th decoder layer 320N and the corresponding output embedding layer 330), as described above with reference to FIG. 3. In addition, the multi-token prediction language model 500 may include the sampling layer 540.

As shown in FIG. 5, the first token predicting head 324A of the multi-token prediction language model 500 may predict a first probability distribution p(xₜ₊₁|x_{1:t}) 526A based on an input token sequence x_{1:t} 502, the second token predicting head 324B may predict a second probability distribution p(xₜ₊₂|x_{1:t}) 526B based on the input token sequence x_{1:t} 502, and the third token predicting head 324C may predict a third probability distribution p(xₜ₊₃|x_{1:t}) 526C based on the input token sequence x_{1:t} 502. That is, each token predicting head of the plurality of token predicting heads 324 may independently predict each of the probability distributions 526A to 526C. The probability distributions 526A to 526C may be provided to the sampling layer 540.

The sampling layer 540 may include a plurality of top-k components 542 (e.g., a first top-k component 542A, a second top-k component 542B, and a third top-k component 542C), a joint estimation component 544, a co-occurrence weighted masking component 546, an adaptive thresholding component 548, and a back off component 549.

Each of the plurality of top-k components 542 may obtain the independent token predictions from a corresponding token predicting head of the plurality of token predicting heads 324. For example, the first top-k component 542A may obtain the first probability distribution p(xₜ₊₁|x_{1:t}) 526A from the first token predicting head 324A, the second top-k component 542B may obtain the second probability distribution p(xₜ₊₂|x_{1:t}) 526B from the second token predicting head 324B, and the third top-k component 542C may obtain the third probability distribution p(xₜ₊₃|x_{1:t}) 526C from the third token predicting head 324C. As used herein, the probability distributions 526A to 526C may also be referred to as logits.

In an embodiment, each of the plurality of top-k components 542 may select the top-k most likely tokens from the probability distribution and may sample a next token from this subset. For example, if k is five (5) (e.g., k=5), each of the plurality of top-k components 542 may sample a token from the top five (5) tokens with the highest probabilities in the probability distribution provided to the top-k component 542. That is, in such an example, the first top-k component 542A may sample a first token 543A from the top five (5) tokens with the highest probabilities in the first probability distribution p(xₜ₊₁|x_{1:t}) 526A, the second top-k component 542B may sample a second token 543B from the top five (5) tokens with the highest probabilities in the second probability distribution p(xₜ₊₂|x_{1:t}) 526B, and the third top-k component 542C may sample a third token 543C from the top five (5) tokens with the highest probabilities in the third probability distribution p(xₜ₊₃|x_{1:t}) 526C. The first to third selected tokens 543A to 543C may be provided to the joint estimation component 544.

As described above, the first to third selected tokens 543A to 543C may have been predicted independently, and as such, the joint probability distribution p(x_{t+1:t+n}|x_{1:t}) of the independent token predictions may be estimated using an equation similar to Equation 4.

$$\begin{matrix}p ( {x}_{t + 1 : t + n} \vert {x}_{1 : t} ) = {\prod }_{i = 1}^{n} p ( {x}_{t + i} \vert {x}_{1 : t + i - 1} ) \\ \approx {\prod }_{i = 1}^{n} p ( {x}_{t + i} \vert {x}_{1 : t} ) = {\prod }_{i = 1}^{n} {f}_{θ}^{i} ( {x}_{1 : t} )\end{matrix} \qquad [ Eq . 4 ]$$

Referring to Equation 4, f_{θ}ⁱ(x_{1:t}) may represent the prediction of the i-th token predicting head 324 of the multi-token prediction language model 300. The joint estimation component 544 may be configured to estimate the joint probability distribution p(x_{t+1:t+n}|x_{1:t}) of the first to third selected tokens 543A to 543C provided by the plurality of top-k components 542. The joint estimation component 544 may provide the estimate the joint probability distribution p(x_{t+1:t+n}|x_{1:t}) to the co-occurrence weighted masking component 546.

The co-occurrence weighted masking component 546 may be configured to bridge a gap(error) between the estimated joint probability distribution provided by the joint estimation component 544 and a true probability distribution by masking the estimated joint probability distribution using co-occurrence weights.

The joint probability distribution of the first to third selected tokens 543A to 543C may be approximated by directly multiplying the independent marginal distributions. However, such an approximation may assume that the second selected token 543B is independent of the first selected token 543A conditioned on the input token sequence x_{1:t} 302, that the third selected token 543C is independent of the first selected token 543 A and the second selected token 543B, and the like. As a result, such an approximation may ignore that the second selected token 543B does depend on which first selected token 543A is chosen, that the third selected token 543C does depend on which first selected token 543A and which second selected token 543B are chosen, and similarly for subsequent predictions.

For example, if the input token sequence x_{1:t} 302 is equal to “I” (e.g., x_{1:t}:=“I”), the token “to” may be a plausible second selected token 543B as many sentences may lead to such a token sequence (e.g., “I like to”, “I want to”, “I went to”, or the like). However, “am” may also be a plausible first selected token 543A. However, if “am” is sampled as the first selected token 543A, “to” may no longer be a plausible second selected token 543B. Thus, it may be desirable to apply a weight to the joint probability distribution based on a co-occurrence of tokens (e.g., words).

According at least in part to optimal transport theory, the true joint probability distribution p(x_{t+1:t+n}|x_{1:t}) may be calculated using an equation similar to Equation 5.

$$\begin{matrix}p ( {x}_{t + 1 : t + n} \vert {x}_{1 : t} ) = {\prod }_{i = 1}^{n} p ( {x}_{t + i} \vert {x}_{1 : t} ) \frac{p ( {x}_{t + 1 : t + n} \vert {x}_{1 : t} )}{{\prod }_{i = 1}^{n} p ( {x}_{t + i} \vert {x}_{1 : t} )} \\ \approx {\prod }_{i = 1}^{n} {f}_{θ}^{i} ( {x}_{1 : t} ) \frac{\hat{p} ( {x}_{t + 1 : t + n} )}{{\prod }_{i = 1}^{n} \hat{p} ( {x}_{t + i} )}\end{matrix} \qquad [ Eq . 5 ]$$

Referring to Equation 5,

$$\frac{\hat{p} ( {x}_{t + 1 : t + n} )}{{\prod }_{i = 1}^{n} \hat{p} ( {x}_{t + i} )}$$

may represent the co-occurrence weighted mask, and \hat{p}(x_{t+1:t+n}) and \hat{p}(xₜ₊ᵢ) may respectively represent sampled estimates of the joint probability and the prediction of the i-th selected token 543. The sampled estimated joint probability \hat{p}(x_{t+1:t+n}) of the i-th selected token 543 and the sampled estimated prediction probability \hat{p}(xₜ₊ᵢ) of the i-th selected token 543 of the co-occurrence weighted mask may be estimated based on the token counts in the training dataset. Advantageously, the co-occurrence weighted mask does not depend on the input token sequence x_{1:t} 302, and as such, may be calculated prior to the inference phase of the multi-token prediction language model 500.

The adaptive thresholding component 548 may be configured to determine a probability threshold ∈_{b} that may be used to determine a confidence of the joint probability distribution obtained from the co-occurrence weighted masking component 546. For example, the back off component 549 may determine whether to perform a dynamic back off operation based on the confidence of the joint probability distribution. The back off component 549 may perform a dynamic back off to lower-order n-gram prediction.

In an embodiment, the probability threshold ∈_{b} may be set to a static value. For example, the probability threshold ∈_{b} may be predetermined based on one or more design constraints such as, but not limited to, a size of the vocabulary, a size of the training dataset, the number of token heads, or the like.

Alternatively or additionally, the adaptive thresholding component 548 may adaptively adjust the probability threshold ∈ₚ based on the joint probability distribution. In an embodiment, the probability threshold ∈_{b} may be determined using a binarization algorithm that may determine the probability threshold ∈_{b} as a threshold that may separate the probabilities in the joint probability distribution into two classes (e.g., below the threshold and above the threshold).

For example, in a case where the input token sequence x_{1:t} 502 is “How do I make this” (e.g., x_{1:t}:=“How”, “do”, “I”, “make this”), the multi-token prediction language model 500 may predict multiple bigrams such as, but not limited to, “delicious cake” having a probability of 0.3 and “chocolate brownie” having a probability of 0.2. In such an example, rather than using a static threshold to determine whether to back off the prediction order, the adaptive thresholding component 548 may calculate a threshold dynamically through adaptive thresholding. Thus, if the adaptive thresholding component 548 calculates a dynamic threshold of 0.1, the adaptive thresholding component 548 may determine to not back off the prediction and sample from the bigram distribution. Alternatively or additionally, if the adaptive thresholding component 548 calculates a dynamic threshold of 0.4, the adaptive thresholding component 548 may determine to back off the prediction and sample a single token. However, the present disclosure is not limited in this regard.

In an embodiment, the adaptive thresholding component 548 may apply Gaussian blur to the joint probability distribution prior to adaptively determining the probability threshold ∈_{b} using the binarization algorithm.

The back off component 549 may be configured to find peaks in the joint probability distribution of the predicted tokens and sample the detected peaks. That is, when generating multiple predicted tokens, the back off component 549 may determine whether at least one probability value of the predicted tokens exceeds the probability threshold ∈_{b}, and sample the predicted tokens corresponding to the at least one probability value to produce the predicted output token sequence x_{t+1:t+n} 550 (YES at operation 549).

In an embodiment, the back off component 549 may apply the adaptive thresholding on top of the static thresholding described with reference to the adaptive thresholding component 548. For example, the back off component 549 may set all values in the joint probability distribution that are less than the static threshold Ep to zero (0). In addition, the back off component 549 may set all values in the joint probability distribution that are less than the dynamic threshold ∈_{AT} to zero (0).

If no probability value of the joint probability distribution exceeds the probability threshold ∈_{b}ⁿ⁻¹ (NO at operation 549), the back off component 549 may back off to sampling at a lower-order joint probability distribution. Also, the back off component 549 may back off to a lower-order n-gram prediction. For example, in a case where the input token sequence x_{1:t} 502 is “How do I make this” (e.g., x_{1:t}:=“How”, “do”, “I”, “make”, “this”), the multi-token prediction language model 500 may predict multiple bigrams such as, but not limited to, “delicious cake”, “chocolate brownie”, or the like. In such an example, if none of the predicted bigrams have a probability value that exceeds the probability threshold ∈_{b}ⁿ⁻¹, the multi-token prediction language model 500 may back off to predicting a single token from among “delicious”, “chocolate”, or the like. That is, the sampled token may depend on the individual probabilities of each predicted token.

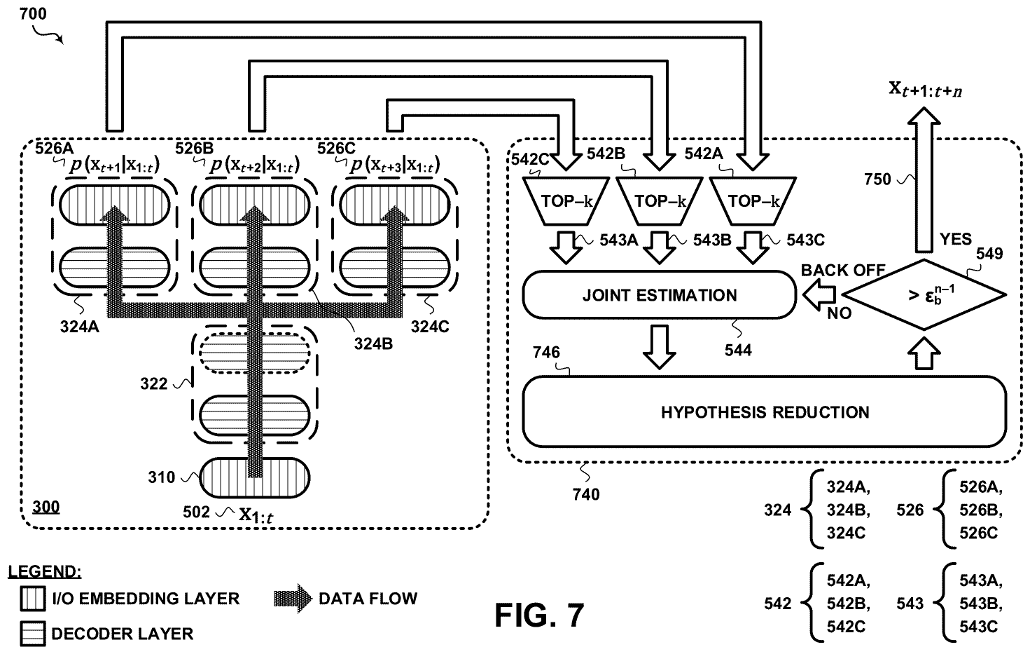

The number and arrangement of components of the multi-token prediction language model 500 shown in FIG. 5 are provided as an example. In practice, there may be additional components, fewer components, different components, or differently arranged components than those shown in FIG. 5. For example, the adaptive thresholding component 548 may be excluded. As another example, the co-occurrence weighted masking component 546 and the adaptive thresholding component 548 may be replaced by a hypothesis reduction component as described with reference to FIG. 7. Furthermore, two or more components shown in FIG. 5 may be implemented within a single component, or a single component shown in FIG. 5 may be implemented as multiple, distributed components. Alternatively or additionally, a set of (one or more) components shown in FIG. 5 may be integrated with each other, and/or may be implemented as an integrated circuit, as software, and/or a combination of circuits and software.

FIG. 6 depicts an exemplary dynamic multi-token prediction language model (DynaMo) multi-token generation algorithm, in accordance with various aspects of the present disclosure.

Referring to FIG. 6, an example of pseudo-code of the DynaMo multi-token generation algorithm 600 that implements one or more aspects of the present disclosure is illustrated. In some embodiments, at least a portion of the multi-token generation algorithm 600 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the multi-token generation algorithm 600. That is, the device 100 may perform a portion of the multi-token generation algorithm 600 as described with reference to FIG. 6 and a remaining portion of the multi-token generation algorithm 600 may be performed by one or more other computing devices.

In some embodiments, the multi-token generation algorithm 600 may be used to implement at least a portion of the multi-token prediction language models 300 and 500 described with reference to FIGS. 3 to 5, and may include additional features not mentioned above.

As shown in FIG. 6, the multi-token generation algorithm 600 may receive an input token sequence x_{1:t}, which may be provided to a DynaMo model with token heads f_{θ}ⁱ, ∀i=1, . . . , n, such as the multi-token prediction language models 300 and 500. The probability distribution output by the i-th token predicting head 324 may be depicted by f_{θ}ⁱ. For example, the first token predicting head f_{θ}¹(x_{1:t}) 324A may output the first probability distribution p(xₜ₊₁|x_{1:t}) 526A based on the input token sequence x_{1:t}, the second token predicting head f_{θ}²(x_{1:t}) 324B may output the second probability distribution p(xₜ₊₂|x_{1:t}) 526B based on the input token sequence x_{1:t}, and the third token predicting head f_{θ}³(x_{1:t}) 324C may output the third probability distribution p(xₜ₊₃|x_{1:t}) 526A based on the input token sequence x_{1:t}, as shown in lines 1 to 3 of the multi-token generation algorithm 600. The probability distributions 526 may be and/or may include a vector of length V. The plurality of top-k components 542 may generate vectors of length k after top-k sampling is performed, as shown in line 6.

In line 7, the joint probability distribution J may be calculated by taking the outer product of the individual token predictions 543. The function adaptiveThresholding, as shown in line 9, may implement adaptive thresholding as described with reference to the adaptive thresholding component 548 of the multi-token prediction language model 500. In line 11, the penalizeRepetition function may divide all probabilities that correspond to repetitions by a penalty value. Lines 12 and 13 may implement a back off function as described with reference to the back off component 549 of the multi-token prediction language model 500. The sample function, as shown in lines 15 and 19, may sample the tokens using multinomial sample (e.g., sampling weighted by the corresponding probability values).

The multi-token generation algorithm 600 may output the sequence of generated tokens x_{t+1:t+n}, based on n. For example, n may be initialized to three (3) (e.g., n=3, as shown in line 4) for the multi-token prediction language models 300 and 500 described with reference to FIGS. 3 to 5. Thus, the multi-token generation algorithm 600 may generate new tokens depending on the output predictions (and the corresponding probabilities).

In an embodiment, a relatively low value of ∈_{b} may generate more tokens. For example, a three-token model (e.g., n=3) with ∈_{b}=0 may typically generate three (3) tokens. Alternatively or additionally, a relatively high value of ∈_{b} may result in fewer tokens being generated. For example, the three-token model (e.g., n=3) with ∈_{b}=1 may typically generate one (1) token.

It is to be understood that the specific order or hierarchy of operations disclosed above with reference to FIG. 6 are an illustration of exemplary approaches. Based upon design preferences, it is to be understood that the specific order or hierarchy of the operations may be rearranged. Further, some operations may be combined and/or omitted.

FIG. 7 illustrates an example of a multi-token prediction language model, in accordance with various aspects of the present disclosure.

Referring to FIG. 7, at least a portion of the operations of the multi-token prediction language model 700 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the multi-token prediction language model 700. That is, the device 100 may perform a portion of the multi-token prediction language model 700 as described with reference to FIG. 7 and a remaining portion of the multi-token prediction language model 700 may be performed by one or more other computing devices.

The multi-token prediction language model 700 of FIG. 7 may include and/or may be similar in many respects to the multi-token prediction language models 300 and 500 described above with reference to FIGS. 3 and 5, and may include additional features not mentioned above. Consequently, repeated descriptions of the multi-token prediction language model 700 and/or its components described above with reference to FIGS. 3 and 5 may be omitted for the sake of brevity.

In an embodiment, the multi-token prediction language model 700 may include the input embedding layer 310, the stem 322 (including the first decoder layer 320A to the (N−1)-th decoder layer 320(N−1)), the plurality of token predicting heads 324 (each token predicting head formed from the corresponding N-th decoder layer 320N and the corresponding output embedding layer 330), as described above with reference to FIGS. 3 and 5. In addition, the multi-token prediction language model 700 may include the sampling layer 740.

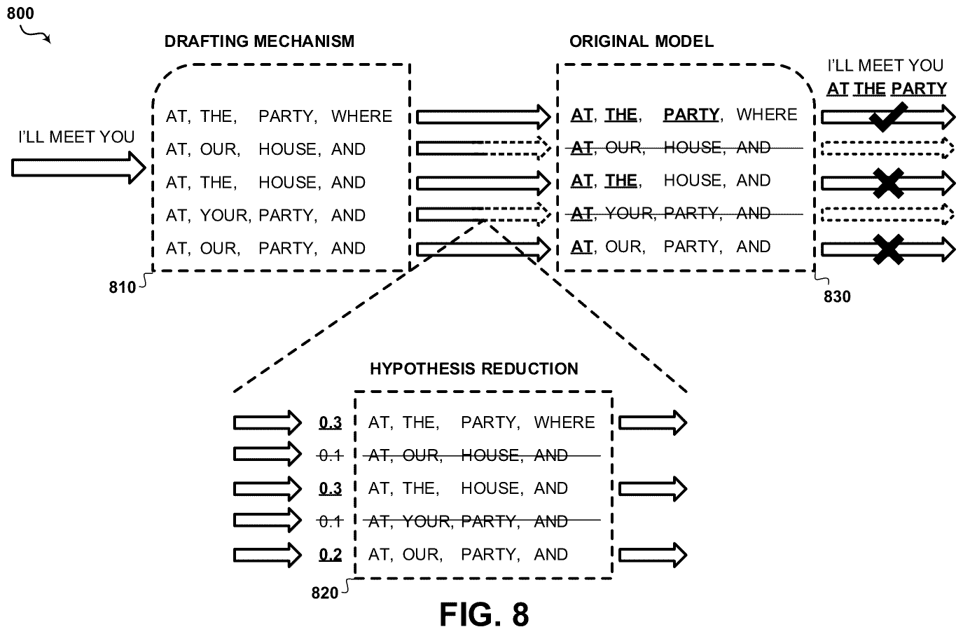

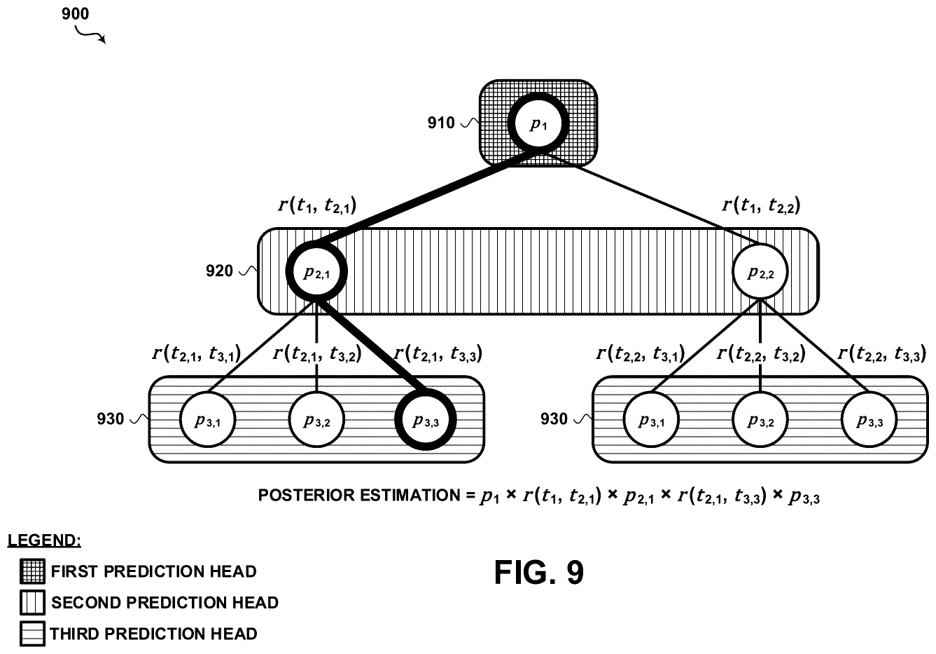

As shown in FIG. 7, the sampling layer 740 may include a hypothesis reduction component 746. The hypothesis reduction component 746 may be configured to reduce a number of the predicted token sequences 543 by using a statistical posterior estimation to select at least one token sequence from the predicted token sequences 543 have a relatively high confidence value. The hypothesis reduction process is described with reference to FIGS. 8 and 9.

The hypothesis reduction component 746 may provide the at least one selected token sequence to the back off component 549 for further processing and sampling, as described above with reference to FIG. 5, to produce the predicted output token sequence x_{t+1:t+n} 750.

FIG. 8 depicts an example of hypothesis reduction, in accordance with various aspects of the present disclosure.

Referring to FIG. 8, an example of the hypothesis reduction process 800 that implements one or more aspects of the present disclosure is illustrated. In some embodiments, at least a portion of the hypothesis reduction process 800 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the hypothesis reduction process 800. That is, the device 100 may perform a portion of the hypothesis reduction process 800 as described with reference to FIG. 8 and a remaining portion of the hypothesis reduction process 800 may be performed by one or more other computing devices.

In some embodiments, the hypothesis reduction process 800 may be implemented by at least a portion of the multi-token prediction language model 700 described with reference to FIG. 7, and may include additional features not mentioned above.

As shown in FIG. 8, the hypothesis reduction process 800 may be and/or may include a three-stage speculative decoding process that may include a hypothesis reduction stage 820 that may perform a posterior estimation to potentially eliminate unlikely candidates, which may facilitate candidate selection in a subsequent stage (e.g., an original model stage 830 or the back off component 549). For example, the hypothesis reduction stage 820 may compute a corrected posterior estimation based on a simple bigram correlation function that may provide a confidence assessment that may be used to prune the hypotheses (e.g., candidate token sequences). In an embodiment, the hypothesis reduction process 800 may be included between the drafting mechanism stage 810 and the original model stage 830.

As used herein, speculative decoding may refer to techniques for predicting subsequent m tokens x_{1:m} simultaneously, given an input prompt h. The speculative decoding may include two sequential stages in each iteration, namely, a speculate stage, and a verify stage. In the speculate stage, the hypothesis reduction process 800 may speculate sequences of the next m tokens. For example, the hypothesis reduction process 800 may rely on a draft model g to approximate the distribution of the next m tokens, which may be expressed as g(h)≈p(x_{1:m}|h) and may generate a set of hypothesized sequences [symbol] . In the verify stage, the original model f may validate each guess.

As shown in FIG. 8, in the speculate stage 810, the hypothesis reduction process 800 may speculate sequences of four (4) tokens (e.g., m=4) from an input prompt h that may be equal to “I'll meet you” (e.g., h:=“I'll”, “meet”, “you”). For example, the sequences may include, but not be limited to, “at the party where”, “at our house and”, “at the house and”, “at your party and”, “at our party and”, or the like. The hypothesis reduction stage 820 that may perform a posterior estimation for each of the speculated sequences and determine to eliminate at least one speculated sequence if the posterior estimation is less than a posterior estimation threshold. For example, as shown in FIG. 8, the hypothesis reduction stage 820 may eliminate speculated sequences having a posterior estimation value less than 0.2. However, the present disclosure is not limited in this regard, and the hypothesis reduction stage 820 may select unlikely sequence candidates in other manners and/or using other threshold values. In an embodiment, the original model 830 may only need to select a predicted token sequence from the reduced set of sequence candidates, and as a result, a computational burden of the original model 830 may be reduced.

In an embodiment, the hypothesis reduction process 800 may identify the longest sequence x_{1:l} satisfying a condition similar to Equation 6 in order to potentially ensure consistency with autoregressive decoding, similar to the autoregressive language prediction model 200 described with reference to FIG. 2 and to the multi-token prediction language models 300, 500, and 700 described with reference to FIGS. 3, 5, and 7.

$${x}_{j} = arg max f ( [ h , {x}_{1 : j - 1} ] ) , \qquad [ Eq . 6 ]$$

$$j = 1 , … , l$$

Referring to Equation 6, the condition xⱼ may be satisfied among all hypothesized sequences {xⱼ}ⱼ∈ [symbol] .

This paradigm may involve a trade-off between the speculate stage and the verify stage. For example, a relatively accurate draft model g may generate more accurate guesses, which may result in a smaller [symbol] and fewer sequences needing verification by the original model 830 during the verification stage. However, designing a draft model may be nontrivial, and a complex model may incur a significant latency during the forward pass of g(h), which may potentially offset benefits of multi-token acceleration in real time. Conversely, a simple draft model may be easier to obtain but may necessitate a larger set [symbol] for verification, which may lead to higher hardware requirements of parallel computing and increased latency.

In various embodiments, the hypothesis reduction process 800 may alleviate the computation burdens in both the speculate and the verify stages by adopting a simple draft model and a hypothesis reduction technique. For example, in the speculate stage, rather than directly approximating the joint distribution of x_{1:m}, the hypothesis reduction process 800 may train m−1 additional prediction heads on top of the same backbone (e.g., stem 322) f to predict the marginal distributions p(xᵢ|h), where i=2, . . . , m. Consequently, a draft model may be formed comprising m−1 models approximating the marginal distributions, gᵢ(h)≈p(xᵢ|h), with each gᵢ having a similar complexity to the original prediction head of f.

The hypothesis set [symbol] may be constructed through the Cartesian product of the top-k selection for each gᵢ alongside the top-1 prediction of f, which may be represented as an equation similar to Equation 7.

$$ℋ = {Top}_{1} ( f ( h ) ) \times {\prod }_{i = 2}^{m} {Top}_{k} ( {g}_{i} ( h ) ) \qquad [ Eq . 7 ]$$

Referring to Equation 7, Topₖ(p) may represent the set of elements with the top k probabilities in the distribution p. In an embodiment, the size of the set of elements may grow exponentially as k^{m-1}.

In an embodiment, the hypothesis reduction process 800 may utilize a hypothesis reduction technique by estimating the posterior probability p(x_{1:m}|h) for each sequence and retaining those with the top k probabilities. In a case that decoding with maximum posterior is Bayes' optimal, such a hypothesis reduction technique may prevent and/or reduce a reduction in accuracy that may be introduced by predicting multiple tokens. Furthermore, the size of the set of elements may be reduced from an exponential function to a linear function of the top-k parameter. Such a reduction may allow the hypothesis reduction process 800 to explore a larger hypothesis set without a need of verifying every hypothesis with the LLM (e.g., the multi-token prediction language model 700). Consequently, the hypothesis reduction process 800 may validate a larger amount of tokens while engaging in less speculation.

In an embodiment, the posterior may be estimated by an equation similar to Equation 8.

$$\hat{p} ( {x}_{1 : m} \vert h ) = {\prod }_{i = 1}^{m} p ( {x}_{i} \vert h ) \times {\prod }_{j = 1}^{m - 1} r ( {x}_{j} , {x}_{j + 1} ) \qquad [ Eq . 8 ]$$

Referring to Equation 8, r:V×V [symbol] [symbol] may represent a fixed correlation function of two adjacent tokens, and p(xᵢ|h) may be approximated by the prediction heads gᵢ(h). The first term in Equation 8 may represent a joint estimation under an assumption of token independence, and the second term may enhance the estimation with a bigram.

FIG. 9 illustrates an example of posterior estimation, in accordance with various aspects of the present disclosure.

Referring to FIG. 9, the hypothesis set [symbol] may be constructed by combining the top-2 and top-3 tokens predicted by second prediction heads 920 and third prediction heads 930. These combinations may be represented as nodes in a tree. In an embodiment, each edge may be assigned a weight equivalent to the correlation r calculated by the endpoint nodes, and each node may be associated with the probability assessed by the prediction heads. As shown in FIG. 9, and according to Equation 8, the posterior probability of a node may be determined by the product of all node probabilities and edge weights along the path leading to it. For example, a selected posterior path that may include nodes p₁, p_{2,1}, and p_{3,3} may be determined to have a posterior estimation of p₁×r(t₁, t_{2,1})×p_{2,1}×r(t_{2,1}, t_{3,3})×p_{3,3}.

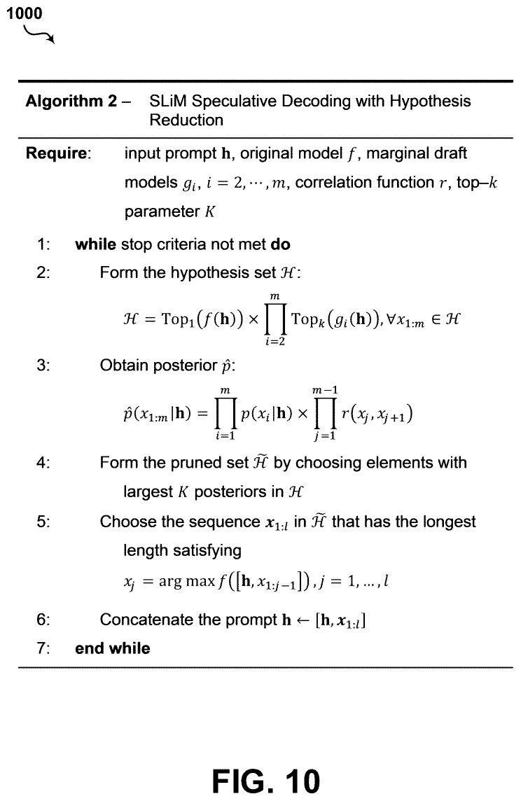

FIG. 10 depicts an exemplary speculative decoding with hypothesis reduction algorithm, in accordance with various aspects of the present disclosure.

Referring to FIG. 10, an example of pseudo-code of the speculative decoding with hypothesis reduction algorithm 1000 that implements one or more aspects of the present disclosure is illustrated. In some embodiments, at least a portion of the speculative decoding with hypothesis reduction algorithm 1000 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the speculative decoding with hypothesis reduction algorithm 1000. That is, the device 100 may perform a portion of the speculative decoding with hypothesis reduction algorithm 1000 as described with reference to FIG. 10 and a remaining portion of the speculative decoding with hypothesis reduction algorithm 1000 may be performed by one or more other computing devices.

In some embodiments, the speculative decoding with hypothesis reduction algorithm 1000 may be used to implement at least a portion of the multi-token prediction language model 700 described with reference to FIG. 7, and may include additional features not mentioned above.

As shown in FIG. 10, the speculative decoding with hypothesis reduction algorithm 1000 may receive, as input, input prompt h, and may further receive and/or be provided with original model f, marginal draft models gᵢ, i=2, . . . , m, correlation function r, and top-k parameter K.

In line 2, the speculative decoding with hypothesis reduction algorithm 1000 may form the hypothesis set [symbol] using Equation 7, for example.

In line 3, the speculative decoding with hypothesis reduction algorithm 1000 may obtain the posterior estimation \hat{p}(x_{1:m}|h) using Equation 8, for example.

In line 4, the speculative decoding with hypothesis reduction algorithm 1000 may form the pruned set [symbol] by choosing elements with largest K posteriors in the hypothesis set [symbol] .

In line 5, the speculative decoding with hypothesis reduction algorithm 1000 may choose the sequences x_{1:l} in the pruned set [symbol] that have the longest length satisfying the condition xⱼ using Equation 6, for example.

In line 6, the speculative decoding with hypothesis reduction algorithm 1000 may concatenate the input prompt h with the selected sequences x_{1:l}.

It is to be understood that the specific order or hierarchy of operations disclosed above with reference to FIG. 10 are an illustration of exemplary approaches. Based upon design preferences, it is to be understood that the specific order or hierarchy of the operations may be rearranged. Further, some operations may be combined and/or omitted.

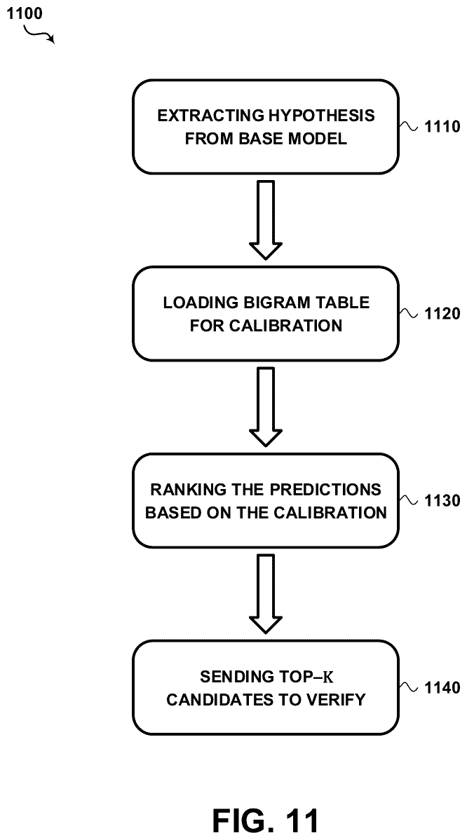

FIG. 11 illustrates an exemplary flowchart of a hypothesis reduction method, in accordance with various aspects of the present disclosure.

Referring to FIG. 11, an exemplary flowchart of a hypothesis reduction method 1100 that implements one or more aspects of the present disclosure is illustrated. In some embodiments, at least a portion of the hypothesis reduction method 1100 may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the hypothesis reduction method 1100. That is, the device 100 may perform a portion of the hypothesis reduction method 1100 as described with reference to FIG. 11 and a remaining portion of the hypothesis reduction method 1100 may be performed by one or more other computing devices.

In some embodiments, the hypothesis reduction method 1100 may be used to implement at least a portion of the multi-token prediction language model 700 described with reference to FIG. 7, and may include additional features not mentioned above.

At block 1110, the hypothesis reduction method 1100 may include extracting a hypothesis set [symbol] from a base model (e.g., the original model stage 830 or the back off component 549).

At block 1120, the hypothesis reduction method 1100 may include loading a bigram table for calibration. For example, the bigram table may be imported in a sparse format to calibrate the predictions of the hypothesis reduction stage 820.

At block 1130, the hypothesis reduction method 1100 may include ranking the posterior estimations based on the calibration.

At block 1140, the hypothesis reduction method 1100 may include sending the top-k candidates to the original model 830 to verify the selected candidates.

It is to be understood that the specific order or hierarchy of blocks in the flowchart disclosed in FIG. 11 is an illustration of an exemplary approach. Based upon design preferences, it is to be understood that the specific order or hierarchy of blocks in the flowchart may be rearranged. Further, some blocks may be combined and/or omitted.

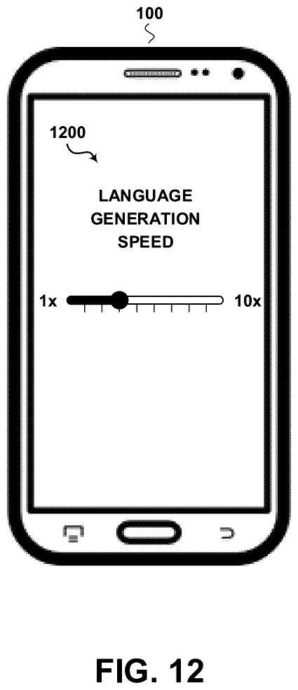

FIG. 12 depicts an example of a user interface (UI) for selecting a language generation speed, in accordance with various aspects of the present disclosure.

Referring to FIG. 12, at least a portion of the UI 1200 for selecting a language generation speed may be performed by the device 100 described with reference to FIG. 1, which may include the dynamic multi-token prediction component 180. Alternatively or additionally, another computing device (e.g., an AI assistance device, a server, a laptop, a smartphone, a UE, a camera, a wearable device, a smart device, an IoT device, or the like), which may include the dynamic multi-token prediction component 180, may perform at least a portion of the UI 1200. That is, the device 100 may perform a portion of the UI 1200 as described with reference to FIG. 12 and a remaining portion of the UI 1200 may be performed by one or more other computing devices.

In some embodiments, the UI 1200 may be used to implement at least a portion of the multi-token prediction language models 300, 500, and 700 as described with reference to FIGS. 3, 5, and 7, and may include additional features not mentioned above.

In some embodiments, a multi-token prediction language model (e.g., at least one of the multi-token prediction language models 300, 500, and 700) may be configured to display (e.g., in a display of the output component 160 of the device 100) a user interface (UI) that may correspond to the UI 1200 for selecting a language generation speed. Alternatively or additionally, the UI 1200 may be displayed by another computing device (e.g., an AI assistance device, a server, a laptop, a smartphone, a UE, a camera, a wearable device, a smart device, an IoT device, or the like), which may include the dynamic multi-token prediction component 180 and/or that may be in communication with the device 100.

The UI 1200 may be configured to provide to, the multi-token prediction language model, a target language generation speed. For example, as shown in FIG. 12, the target language generation speed may be indicated as a multiplication factor that may range between “1×” (e.g., one times multiplier) and “10×” (e.g., ten (10) times multiplier). However, the present disclosure is not limited in this regard. For example, although not shown, the UI 1200 may represent the target language generation speed as ranging between “slow” and “fast”. In an embodiment, the present disclosure may employ any user interface capable of receiving an indication of a target language generation speed.

The multi-token prediction language model may determine, based on the target language generation speed, a target number of output tokens to be included in the predicted output token sequence. That is, the multi-token prediction language model may increase the number of output tokens to be included in the predicted output token sequence if or when the target language generation speed is increased. Alternatively or additionally, the multi-token prediction language model may decrease the number of output tokens to be included in the predicted output token sequence if or when the target language generation speed is decreased. Consequently, the multi-token prediction language model may predict a target number of output tokens that may correspond to the target language generation speed.

In an embodiment, the multi-token prediction language model may adjust the probability threshold ∈_{b} commensurate with the target number of output tokens. For example, the multi-token prediction language model may decrease and/or increase the probability threshold ∈_{b} in order to ensure that the multi-token prediction language model may output the target number of output tokens that corresponds to the target language generation speed selected in the UI 1200. However, the present disclosure is not limited in this regard. For example, the multi-token prediction language model may not adjust the probability threshold ∈_{b} based on changes to the target number of output tokens or to the target language generation speed.

In an embodiment, the methods, apparatuses, systems, and non-transitory computer-readable mediums for accelerating language model inference with dynamic multi-token sampling, described above with reference to FIGS. 1 to 12, may achieve speed improvements, when compared to related language models, while generating text with a substantially similar quality as related language models. Thus, the aspects presented herein may provide for devices and/or services that may be based on LLMs to be deployed to resource-constrained edge platforms (e.g., mobile devices, smart devices, IoT devices, or the like).

Furthermore, aspects presented herein provide for multi-token prediction language models that may dynamically predict multiple tokens based on a confidence in a predicted joint probability distribution. In addition, aspects presented herein may provide for training the multi-token prediction language models in a manner that may leverage the weights of related autoregressive language models. Additionally, aspects presented herein may provide for systematic qualitative and/or quantitative methods to test the quality of text generated by the multi-token prediction language models. The aspects described herein may also be applicable to other machine learning technologies and the standards that employ these technologies.

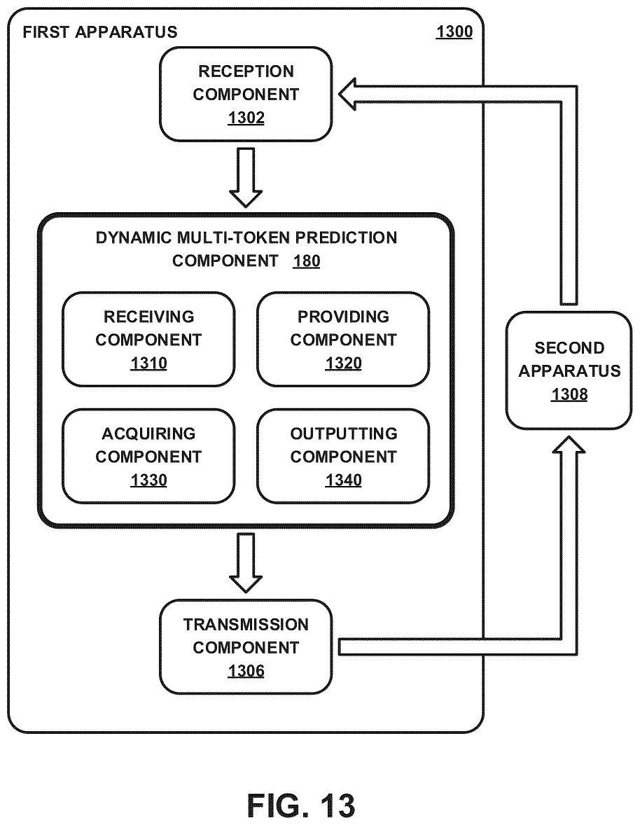

FIG. 13 illustrates a block diagram of an example apparatus for performing multi-token prediction, in accordance with an aspect of the present disclosure. The first apparatus 1300 may be a computing device (e.g., device 100 of FIG. 1) and/or a computing device may include the first apparatus 1300. In some embodiments, the first apparatus 1300 may include a reception component 1302 configured to receive communications (e.g., wired, wireless) from another apparatus (e.g., a second apparatus 1308), a dynamic multi-token prediction component 180 configured to perform multi-token prediction, and a transmission component 1306 configured to transmit communications (e.g., wired, wireless) to another apparatus (e.g., the second apparatus 1308). The components of the first apparatus 1300 may be in communication with one another (e.g., via one or more buses or electrical connections). As shown in FIG. 13, the first apparatus 1300 may be in communication with the second apparatus 1308 (such as, but not limited to, an AI assistance device, a server, a laptop, a smartphone, a UE, a camera, a wearable device, a smart device, an IoT device, or the like) using the reception component 1302 and/or the transmission component 1306.

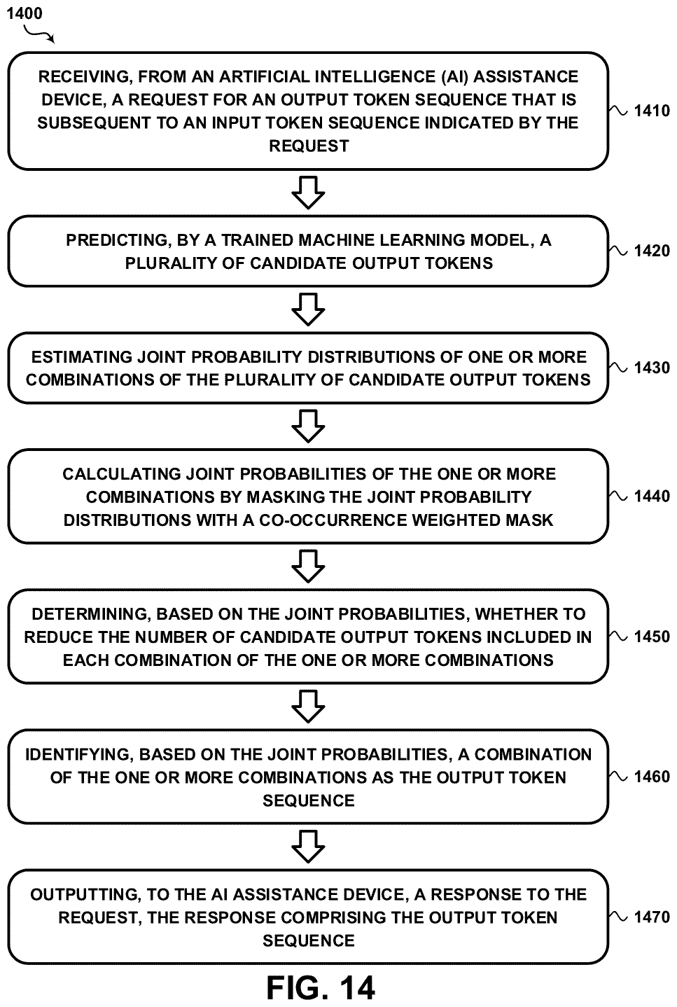

In some embodiments, the first apparatus 1300 may be configured to perform one or more operations described herein in connection with FIGS. 1 to 12. Alternatively or additionally, the first apparatus 1300 may be configured to perform one or more processes described herein, such as method 1400 of FIG. 14. In an embodiment, the first apparatus 1300 may include one or more components of the device 100 described with reference to FIG. 1.

The reception component 1302 may receive communications, such as control information, data communications, or a combination thereof, from the second apparatus 1308 (e.g., an AI assistance device, a server, a laptop, a smartphone, a UE, a camera, a wearable device, a smart device, an IoT device, or the like). The reception component 1302 may provide received communications to one or more other components of the first apparatus 1300, such as the dynamic multi-token prediction component 180. In some embodiments, the reception component 1302 may perform signal processing on the received communications, and may provide the processed signals to the one or more other components. In some embodiments, the reception component 1302 may include one or more antennas, a receive processor, a controller/processor, a memory, or a combination thereof, of the device 100 described with reference to FIG. 1.

The transmission component 1306 may transmit communications, such as control information, data communications, or a combination thereof, to the second apparatus 1308 (e.g., an AI assistance device, a server, a laptop, a smartphone, a UE, a camera, a wearable device, a smart device, an IoT device, or the like). In some embodiments, the dynamic multi-token prediction component 180 may generate communications and may transmit the generated communications to the transmission component 1306 for transmission to the second apparatus 1308. In some embodiments, the transmission component 1306 may perform signal processing on the generated communications, and may transmit the processed signals to the second apparatus 1308. In other embodiments, the transmission component 1306 may include one or more antennas, a transmit processor, a controller/processor, a memory, or a combination thereof, of the device 100 described with reference to FIG. 1. In some embodiments, the transmission component 1306 may be co-located with the reception component 1302 such as in a transceiver and/or a transceiver component.

The dynamic multi-token prediction component 180 may be configured to perform multi-token prediction. In some embodiments, the dynamic multi-token prediction component 180 may include a set of components, such as a receiving component 1310 configured to receive a request for an output token sequence, a predicting component 1320 configured to predict a plurality of candidate output tokens, an estimating component 1330 configured to estimate joint probability distributions of one or more combinations of the plurality of candidate output tokens, a calculating component 1340 configured to calculate joint probabilities of the one or more combinations, a determining component 1350 configured to determine whether to reduce the number of candidate output tokens included in each combination of the one or more combinations, an identifying component 1360 configured to identify a combination of the one or more combinations as the output token sequence, and an outputting component 1370 configured to output a response to the request including the output token sequence.

In some embodiments, the set of components may be separate and distinct from the dynamic multi-token prediction component 180. In other embodiments, one or more components of the set of components may include or may be implemented within a controller/processor (e.g., the processor 120), a memory (e.g., the memory 130), or a combination thereof, of the device 100 described above with reference to FIG. 1. Alternatively or additionally, one or more components of the set of components may be implemented at least in part as software stored in a memory, such as the memory 130. For example, a component (or a portion of a component) may be implemented as computer-executable instructions or code stored in a computer-readable medium (e.g., a non-transitory computer-readable medium) and executable by a controller or a processor to perform the functions or operations of the component.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIGS. 1 to 12.

Referring to FIG. 14, in operation, an first apparatus 1300 may perform a method 1400 of performing multi-token prediction. The method 1400 may be performed by at least one of the device 100 (which may include the processor 120, the memory 130, and the storage component 140, and which may be the entire device 100 and/or include one or more components of the device 100, such as the input component 150, the output component 160, the communication interface 170, and/or the dynamic multi-token prediction component 180) and/or the first apparatus 1300. The method 1400 may be performed by the device 100, the first apparatus 1300, and/or the dynamic multi-token prediction component 180 in communication with the second apparatus 1308 (e.g., an AI assistance device, a server, a laptop, a smartphone, a UE, a camera, a wearable device, a smart device, an IoT device, or the like).

At block 1410 of FIG. 14, the method 1400 may include receiving, from an AI assistance device, a request for an output token sequence that is subsequent to an input token sequence indicated by the request. For example, in an aspect, the device 100, the dynamic multi-token prediction component 180, and/or the receiving component 1310 may be configured to or may include means for receiving, from an AI assistance device, a request for an output token sequence 342 that is subsequent to an input token sequence 302 indicated by the request.

In an embodiment, the receiving at block 1410 may include receiving the request from an AI assistance device, as described above with reference to FIG. 3.

At block 1420 of FIG. 14, the method 1400 may include predicting, by a trained machine learning model, a plurality of candidate output tokens, the trained machine learning model having been trained to simultaneously predict the plurality of candidate output tokens based on the input token sequence. For example, in an aspect, the device 100, the dynamic multi-token prediction component 180, and/or the predicting component 1320 may be configured to or may include means for predicting, by a trained machine learning model 300, a plurality of candidate output tokens 342, the trained machine learning model 300 having been trained to simultaneously predict the plurality of candidate output tokens 342 based on the input token sequence 302.

In an embodiment, the predicting at block 1420 may include predicting each output token of the plurality of candidate output tokens by a corresponding token head of a plurality of token heads in a forward pass of the trained machine learning model. In an embodiment, each corresponding token head may be configured to provide a candidate output token in a corresponding position of the output token sequence.

In an optional or additional embodiment, the predicting at block 1420 may further include predicting, by each corresponding token head of the plurality of token heads of the trained machine learning model, a plurality of logits corresponding to the plurality of candidate output tokens, selecting, for each corresponding token head of the plurality of token heads, a number of candidate output tokens from the target tokens based on probabilities of the plurality of logits, determining the one or more combinations by grouping a candidate output token from each corresponding token head.

In another optional or additional embodiment, the predicting at block 1420 may further include identifying, based on determining that the combination exceeds the probability threshold, the combination as the output token sequence.

In yet another optional or additional embodiment, the predicting at block 1420 may further include, based on determining that the one or more combinations do not exceed the probability threshold, determining new candidate token combinations comprising candidate output tokens from a portion of the plurality of token heads, the portion of the plurality of token heads excluding at least one token head, calculating joint probabilities for the new candidate token combinations, and determining whether the joint probabilities of the new candidate token combinations exceed the probability threshold.

In another optional or additional embodiment, the predicting at block 1420 may further include adapting the probability threshold based on the joint probability of the candidate output tokens using a binarization algorithm.

In yet another optional or additional embodiment, the predicting at block 1420 may further include estimating a posterior probability of each combination of the one or more combinations using a bigram correlation function, and eliminating one or more combinations from the one or more combinations based on the posterior probabilities of the one or more combinations.

At block 1430 of FIG. 14, the method 1400 may include estimating joint probability distributions of one or more combinations of the plurality of candidate output tokens, each combination of the one or more combinations having a number of candidate output tokens that corresponds to a target language generation speed. For example, in an aspect, the device 100, the dynamic multi-token prediction component 180, and/or the estimating component 1330 may be configured to or may include means for estimating joint probability distributions of one or more combinations of the plurality of candidate output tokens, each combination of the one or more combinations having a number of candidate output tokens that corresponds to a target language generation speed.

In an embodiment, the estimating at block 1430 may include calculating, for each combination of the one or more combinations, a joint probability of candidate output tokens associated with the corresponding combination.

At block 1440 of FIG. 14, the method 1400 may include calculating joint probabilities of the one or more combinations by masking the joint probability distributions with a co-occurrence weighted mask. For example, in an aspect, the device 100, the dynamic multi-token prediction component 180, and/or the calculating component 1340 may be configured to or may include means for calculating joint probabilities of the one or more combinations by masking the joint probability distributions with a co-occurrence weighted mask.

In an embodiment, the co-occurrence weighted mask may be independent of the input token sequence.

At block 1450 of FIG. 14, the method 1400 may include determining, based on the joint probabilities, whether to reduce the number of candidate output tokens included in each combination of the one or more combinations. For example, in an aspect, the device 100, the dynamic multi-token prediction component 180, and/or the determining component 1350 may be configured to or may include means for determining, based on the joint probabilities, whether to reduce the number of candidate output tokens included in each combination of the one or more combinations.

In an embodiment, the determining at block 1450 may include determining whether at least one combination of the one or more combinations has a joint probability exceeding a probability threshold.

At block 1460 of FIG. 14, the method 1400 may include identifying, based on the joint probabilities, a combination of the one or more combinations as the output token sequence. For example, in an aspect, the device 100, the dynamic multi-token prediction component 180, and/or the identifying component 1360 may be configured to or may include means for identifying, based on the joint probabilities, a combination of the one or more combinations as the output token sequence.

At block 1470 of FIG. 14, the method 1400 may include outputting, to the AI assistance device, a response to the request, the response comprising the output token sequence. For example, in an aspect, the device 100, the dynamic multi-token prediction component 180, and/or the outputting component 1370 may be configured to or may include means for outputting, to the AI assistance device, a response to the request, the response comprising the output token sequence.

In an optional or additional aspect that may be combined with any other aspects, the method 1400 may further include transferring, from a trained base model, weight information to a model stem and a first token head of a plurality of token heads of an untrained machine learning model, initializing weight information of remaining token heads of the plurality of token heads with randomized information, and training the model stem and the first token head at a first learning rate and training the remaining token heads at second learning rate to obtain the trained machine learning model. In an embodiment, the second learning rate may be greater than the first learning rate.

In another optional or additional aspect that may be combined with any other aspects, the method 1400 may further include receiving, from the AI assistance device, a target language generation speed, determining, based on the target language generation speed, a target number of output tokens to be included in the predicted output token sequence, and predicting the target number of output tokens by a corresponding number of token heads of a plurality of token heads of the trained machine learning model.

The following aspects are illustrative only and aspects thereof may be combined with aspects of other embodiments or teaching described herein, without limitation.
Aspect 1 is a method for performing multi-token prediction by an apparatus includes receiving, from an AI assistance device, a request for an output token sequence that is subsequent to an input token sequence indicated by the request, predicting, by a trained machine learning model, a plurality of candidate output tokens, estimating joint probability distributions of one or more combinations of the plurality of candidate output tokens, calculating joint probabilities of the one or more combinations by masking the joint probability distributions with a co-occurrence weighted mask, determining, based on the joint probabilities, whether to reduce the number of candidate output tokens included in each combination of the one or more combinations, identifying, based on the joint probabilities, a combination of the one or more combinations as the output token sequence, and outputting, to the AI assistance device, a response to the request. The trained machine learning model has been trained to simultaneously predict the plurality of candidate output tokens based on the input token sequence. Each combination of the one or more combinations has a number of candidate output tokens that corresponds to a target language generation speed. The response includes the output token sequence.
In Aspect 2, the method of Aspect 1 may include predicting each output token of the plurality of candidate output tokens by a corresponding token head of a plurality of token heads in a forward pass of the trained machine learning model. Each corresponding token head may be configured to provide a candidate output token in a corresponding position of the output token sequence.
In Aspect 3, the method of Aspect 2 may include predicting, by each corresponding token head of the plurality of token heads of the trained machine learning model, a plurality of logits corresponding to the plurality of candidate output tokens, selecting, for each corresponding token head of the plurality of token heads, a number of candidate output tokens from the target tokens based on probabilities of the plurality of logits, determining the one or more combinations by grouping a candidate output token from each corresponding token head. The estimating of the joint probability distributions may include calculating, for each combination of the one or more combinations, a joint probability of candidate output tokens associated with the corresponding combination. The determining whether to reduce the number of candidate output tokens may include determining whether at least one combination of the one or more combinations has a joint probability exceeding a probability threshold.
In Aspect 4, the method of Aspect 3 may include identifying, based on determining that the combination exceeds the probability threshold, the combination as the output token sequence.
In Aspect 5, the method of any of Aspects 3 or 4 may include, based on determining that the one or more combinations do not exceed the probability threshold, determining new candidate token combinations including candidate output tokens from a portion of the plurality of token heads, calculating joint probabilities for the new candidate token combinations, and determining whether the joint probabilities of the new candidate token combinations exceed the probability threshold. The portion of the plurality of token heads may exclude at least one token head.
In Aspect 6, the co-occurrence weighted mask of the method of any of Aspects 1 to 5 may be independent of the input token sequence.
In Aspect 7, the method of any of Aspects 3 to 6 may include adapting the probability threshold based on the joint probability of the candidate output tokens using a binarization algorithm.
In Aspect 8, the method of any of Aspects 3 to 7 may include estimating a posterior probability of each combination of the one or more combinations using a bigram correlation function, and eliminating one or more combinations from the one or more combinations based on the posterior probabilities of the one or more combinations.
In Aspect 9, the method of any of Aspects 2 to 8 may include transferring, from a trained base model, weight information to a model stem and a first token head of a plurality of token heads of an untrained machine learning model, initializing weight information of remaining token heads of the plurality of token heads with randomized information, and training the model stem and the first token head at a first learning rate and training the remaining token heads at second learning rate to obtain the trained machine learning model. The second learning rate may be greater than the first learning rate.
In Aspect 10, the method of any of Aspects 1 to 9 may include receiving, from the AI assistance device, the target language generation speed, determining, based on the target language generation speed, a target number of output tokens to be included in the output token sequence, and predicting the target number of output tokens by a corresponding number of token heads of a plurality of token heads of the trained machine learning model.
Aspect 11 is an apparatus for performing multi-token prediction. The apparatus includes one or more processors communicatively including processing circuitry, and memory storing instructions. The instructions, when executed by the one or more processors individually or collectively, cause the apparatus to perform one or more of the methods of any of Aspects 1 to 10.
Aspect 12 is an apparatus for performing multi-token prediction. The apparatus includes means for performing one or more of the methods of any of Aspects 1 to 10.
Aspect 13 is a non-transitory computer-readable storage medium storing computer-executable instructions for performing multi-token prediction by an apparatus. The computer-executable instructions are configured, when executed by one or more processors of the apparatus, to cause the apparatus to perform one or more of the methods of any of Aspects 1 to 10.
Aspect 14 is a system for performing multi-token prediction. The system includes an AI assistance device and an apparatus. The apparatus one or more processors including processing circuitry, and memory storing instructions. The instructions, when executed by the one or more processors individually or collectively, cause the apparatus to perform one or more of the methods of any of Aspects 1 to 10.

The foregoing disclosure provides illustration and description, but may not be intended to be exhaustive or to limit the implementations to the precise form disclosed. Modifications and variations are possible in light of the above disclosure or may be acquired from practice of the implementations.

For example, the terms “component,” “module,” “system” or the like are intended to include a computer-related entity, such as but not limited to hardware, firmware, a combination of hardware and software, software, or software in execution. For example, a component may be, but may not be limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations. Non-transitory computer-readable media may exclude transitory signals.

The computer readable storage medium may be a tangible device that may retain and store instructions for use by an instruction execution device. The computer readable storage medium may be, for example, but may not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EEPROM or Flash memory), a static random access memory (SRAM), a portable compact disc read-only memory (CD-ROM), a DVD, a memory stick, a floppy disk, a mechanically encoded device such as punch-cards or raised structures in a groove having instructions recorded thereon, and any suitable combination of the foregoing. A computer readable storage medium, for example, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local-area network (LAN) or a wide-area network (WAN), or the connection may be made to an external computer (for example, through the Internet using an internet service provider). In some embodiments, electronic circuitry including, for example, programmable logic circuitry, field programmable gate arrays (FPGA), and/or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

At least one of the components, elements, modules or units (collectively “components” in this paragraph) represented by a block in the drawings may be embodied as various numbers of hardware, software and/or firmware structures that execute respective functions described above, according to an example embodiment. According to example embodiments, at least one of these components may use a direct circuit structure, such as a memory, a processor, a logic circuit, a look-up table, or the like, that may execute the respective functions through controls of one or more microprocessors or other control apparatuses. Also, at least one of these components may be specifically embodied by a module, a program, or a part of code, which may contain one or more executable instructions for performing specified logic functions, and may be executed by one or more microprocessors or other control apparatuses. Further, at least one of these components may include or may be implemented by a processor such as a central processing unit (CPU) that may perform the respective functions, a microprocessor, or the like. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors. Furthermore, the components represented by a block or processing steps may employ any number of related art techniques for electronics configuration, signal processing and/or control, data processing or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The flowchart and block diagrams in the drawings illustrate the architecture, functionality, and operation of possible implementations of systems, methods, and computer readable media according to various embodiments. In this regard, each block in the flowchart or block diagrams may represent a module, segment, or portion of instructions, which includes one or more executable instructions for implementing the specified logical functions. The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It may be apparent that systems and/or methods, described herein, may be implemented in different forms of hardware, firmware, or a combination of hardware and software. The actual specialized control hardware or software code used to implement these systems and/or methods may not be limiting of the implementations. Thus, the operation and behavior of the systems and/or methods were described herein without reference to specific software code-it being understood that software and hardware may be designed to implement the systems and/or methods based on the description herein.

No element, act, or instruction described in the present disclosure should be construed as critical or essential unless explicitly described as such. Also, for example, the articles “a” and “an” may be intended to include one or more items, and may be used interchangeably with “one or more.” Furthermore, for example, the term “set” may be intended to include one or more items (e.g., related items, unrelated items, a combination of related and unrelated items, or the like), and may be used interchangeably with “one or more.” Where only one item may be intended, the term “one” or similar language may be used. Also, for example, the terms “has,” “have,” “having,” “includes,” “including,” or the like may be intended to be open-ended terms. Further, the phrase “based on” may be intended to mean “based, at least in part, on” unless explicitly stated otherwise. In addition, expressions such as “at least one of [A] and [B]” or “at least one of [A] or [B]” may be understood to include only A, only B, or both A and B.

Reference throughout this specification to “one embodiment,” “an embodiment,” or similar language may indicate that a particular feature, structure, or characteristic described in connection with the indicated embodiment may be included in at least one embodiment of the present solution. Thus, the phrases “in one embodiment”, “in an embodiment,” and similar language throughout this specification may, but do not necessarily, all refer to the same embodiment. For example, such terms as “1st” and “2nd,” or “first” and “second” may be used to simply distinguish a corresponding component from another, and does not limit the components in other aspects (e.g., importance or order). It may be understood that if an element (e.g., a first element) may be referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It may be understood that when an element or layer may be referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element may be referred to as being “directly over,” “directly above,” “directly on,” “directly below,” “directly under,” “directly beneath,” “directly connected to” or “directly coupled to” another element or layer, there are no intervening elements or layers present.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations may be apparent to those of ordinary skill in the art without departing from the scope of the described embodiments. The terminology used herein may be chosen to best explain the principles of the embodiments, the practical application or technical improvement over technologies found in the marketplace, or to enable others of ordinary skill in the art to understand the embodiments disclosed herein.

It may be understood that the specific order or hierarchy of blocks in the processes/flowcharts disclosed are an illustration of exemplary approaches. Based upon design preferences, it may be understood that the specific order or hierarchy of blocks in the processes/flowcharts may be rearranged. Further, some blocks may be combined and/or omitted. The accompanying claims present elements of the various blocks in a sample order, and are not meant to be limited to the specific order or hierarchy presented.

Furthermore, the described features, advantages, and characteristics of the present disclosure may be combined in any suitable manner in one or more embodiments. One skilled in the relevant art may recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

1. A method for performing multi-token prediction by an apparatus, the method comprising:
receiving, from an artificial intelligence (AI) assistance device, a request for an output token sequence that is subsequent to an input token sequence indicated by the request;
predicting, by a trained machine learning model, a plurality of candidate output tokens, the trained machine learning model having been trained to simultaneously predict the plurality of candidate output tokens based on the input token sequence;
estimating joint probability distributions of one or more combinations of the plurality of candidate output tokens, each combination of the one or more combinations having a number of candidate output tokens that corresponds to a target language generation speed;
calculating joint probabilities of the one or more combinations by masking the joint probability distributions with a co-occurrence weighted mask;
determining, based on the joint probabilities, whether to reduce the number of candidate output tokens included in each combination of the one or more combinations;
identifying, based on the joint probabilities, a combination of the one or more combinations as the output token sequence; and
outputting, to the AI assistance device, a response to the request, the response comprising the output token sequence.

2. The method of claim 1, wherein the predicting of the plurality of candidate output tokens comprises:
predicting each output token of the plurality of candidate output tokens by a corresponding token head of a plurality of token heads in a forward pass of the trained machine learning model, each corresponding token head being configured to provide a candidate output token in a corresponding position of the output token sequence.

3. The method of claim 2, wherein the predicting of each output token of the plurality of candidate output tokens comprises:
predicting, by each corresponding token head of the plurality of token heads of the trained machine learning model, a plurality of logits corresponding to the plurality of candidate output tokens;
selecting, for each corresponding token head of the plurality of token heads, a number of candidate output tokens from the target tokens based on probabilities of the plurality of logits;
determining the one or more combinations by grouping a candidate output token from each corresponding token head,
wherein the estimating of the joint probability distributions comprises calculating, for each combination of the one or more combinations, a joint probability of candidate output tokens associated with the corresponding combination, and
wherein the determining whether to reduce the number of candidate output tokens comprises determining whether at least one combination of the one or more combinations has a joint probability exceeding a probability threshold.

4. The method of claim 3, wherein the identifying of the combination of the one or more combinations comprises:
identifying, based on determining that the combination exceeds the probability threshold, the combination as the output token sequence.

5. The method of claim 3, further comprising, based on determining that the one or more combinations do not exceed the probability threshold:
determining new candidate token combinations comprising candidate output tokens from a portion of the plurality of token heads, the portion of the plurality of token heads excluding at least one token head;
calculating joint probabilities for the new candidate token combinations; and
determining whether the joint probabilities of the new candidate token combinations exceed the probability threshold.

6. The method of claim 1, wherein the co-occurrence weighted mask is independent of the input token sequence.

7. The method of claim 3, further comprising:
adapting the probability threshold based on the joint probability of the candidate output tokens using a binarization algorithm.

8. The method of claim 3, wherein the determining of the one or more combinations comprises:
estimating a posterior probability of each combination of the one or more combinations using a bigram correlation function; and
eliminating one or more combinations from the one or more combinations based on the posterior probabilities of the one or more combinations.

9. The method of claim 2, further comprising:
transferring, from a trained base model, weight information to a model stem and a first token head of a plurality of token heads of an untrained machine learning model;
initializing weight information of remaining token heads of the plurality of token heads with randomized information; and
training the model stem and the first token head at a first learning rate and training the remaining token heads at second learning rate to obtain the trained machine learning model,
wherein the second learning rate is greater than the first learning rate.

10. The method of claim 1, further comprising:
receiving, from the AI assistance device, the target language generation speed; and
determining, based on the target language generation speed, a target number of output tokens to be included in the output token sequence,
wherein the predicting of the plurality of candidate output tokens comprises predicting the target number of output tokens by a corresponding number of token heads of a plurality of token heads of the trained machine learning model.

11. An apparatus for performing multi-token prediction, comprising:
one or more processors comprising processing circuitry; and
memory storing instructions,
wherein the instructions, when executed by the one or more processors individually or collectively, cause the apparatus to:
receive, from an artificial intelligence (AI) assistance device, a request for an output token sequence that is subsequent to an input token sequence indicated by the request;
predict, by a trained machine learning model, a plurality of candidate output tokens, the trained machine learning model having been trained to simultaneously predict the plurality of candidate output tokens based on the input token sequence;
estimate joint probability distributions of one or more combinations of the plurality of candidate output tokens, each combination of the one or more combinations having a number of candidate output tokens that corresponds to a target language generation speed;
calculate joint probabilities of the one or more combinations by masking the joint probability distributions with a co-occurrence weighted mask;
determine, based on the joint probabilities, whether to reduce the number of candidate output tokens included in each combination of the one or more combinations;
identify, based on the joint probabilities, a combination of the one or more combinations as the output token sequence; and
output, to the AI assistance device, a response to the request, the response comprising the output token sequence.

12. The apparatus of claim 11, wherein the instructions, when executed by the one or more processors, further cause the apparatus to:
predict each output token of the plurality of candidate output tokens by a corresponding token head of a plurality of token heads in a forward pass of the trained machine learning model, each corresponding token head being configured to provide a candidate output token in a corresponding position of the output token sequence.

13. The apparatus of claim 12, wherein the instructions, when executed by the one or more processors, further cause the apparatus to:
predict, by each corresponding token head of the plurality of token heads of the trained machine learning model, a plurality of logits corresponding to the plurality of candidate output tokens;
select, for each corresponding token head of the plurality of token heads, a number of candidate output tokens from the target tokens based on probabilities of the plurality of logits;
determine the one or more combinations by grouping a candidate output token from each corresponding token head;
calculate, for each combination of the one or more combinations, a joint probability of candidate output tokens associated with the corresponding combination, and
determine whether at least one combination of the one or more combinations has a joint probability exceeding a probability threshold.

14. The apparatus of claim 13, wherein the instructions, when executed by the one or more processors, further cause the apparatus to:
identify, based on determining that the combination exceeds the probability threshold, the combination as the output token sequence.

15. The apparatus of claim 13, wherein the instructions, when executed by the one or more processors, further cause the apparatus, based on a determination that the one or more combinations do not exceed the probability threshold, to:
determine new candidate token combinations comprising candidate output tokens from a portion of the plurality of token heads, the portion of the plurality of token heads excluding at least one token head;
calculate joint probabilities for the new candidate token combinations; and
determine whether the joint probabilities of the new candidate token combinations exceed the probability threshold.

16. The apparatus of claim 13, wherein the co-occurrence weighted mask is independent of the input token sequence.

17. The apparatus of claim 13, wherein the instructions, when executed by the one or more processors, further cause the apparatus to:
adapt the probability threshold based on the joint probability of the candidate output tokens using a binarization algorithm.

18. The apparatus of claim 13, wherein the instructions, when executed by the one or more processors, further cause the apparatus to:
estimate a posterior probability of each combination of the one or more combinations using a bigram correlation function; and
eliminate one or more combinations from the one or more combinations based on the posterior probabilities of the one or more combinations.

19. A system for performing multi-token prediction, comprising:
an artificial intelligence (AI) assistance device; and
an apparatus, comprising:
one or more processors comprising processing circuitry; and
memory storing instructions,
wherein the instructions, when executed by the one or more processors individually or collectively, cause the apparatus to:
receive, from the AI assistance device, a request for an output token sequence that is subsequent to an input token sequence indicated by the request;
predict, by a trained machine learning model, a plurality of candidate output tokens, the trained machine learning model having been trained to simultaneously predict the plurality of candidate output tokens based on the input token sequence;
estimate joint probability distributions of one or more combinations of the plurality of candidate output tokens, each combination of the one or more combinations having a number of candidate output tokens that corresponds to a target language generation speed;
calculate joint probabilities of the one or more combinations by masking the joint probability distributions with a co-occurrence weighted mask;
determine, based on the joint probabilities, whether to reduce the number of candidate output tokens included in each combination of the one or more combinations;
identify, based on the joint probabilities, a combination of the one or more combinations as the output token sequence; and
output, to the AI assistance device, a response to the request, the response comprising the output token sequence.

20. The system of claim 19, wherein the instructions, when executed by the one or more processors, further cause the apparatus to:
predict each output token of the plurality of candidate output tokens by a corresponding token head of a plurality of token heads in a forward pass of the trained machine learning model, each corresponding token head being configured to provide a candidate output token in a corresponding position of the output token sequence.
